(19) United States
(12) Patent Application Publication
(10) Pub. No.: US 2025/0006995 A1
(43) Pub. Date: Jan. 2, 2025

(54) CATHOLYTES FOR A SOLID-STATE BATTERY

(71) Applicant: QUANTUMSCAPE BATTERY, INC., San Jose, CA (US)

(72) Inventors: Aram YANG, San Jose, CA (US); Jan CHAN, San Jose, CA (US)

(21) Appl. No.: 18/703,169

(22) PCT Filed: Nov. 30, 2022
(86) PCT No.: PCT/US2022/051433

§ 371 Date: Apr. 19, 2024

Related U.S. Application Data
(60) Provisional application No. 63/264,693, filed on Nov. 30, 2021.

(51) Int. Cl. H01M 10/0568; H01M 10/052; H01M 10/0562; H01M 10/0567

(52) U.S. Cl. CPC H01M 10/0568; H01M 10/052; H01M 10/0562; H01M 10/0567; H01M 2220/20; H01M 2300/0068

(57) ABSTRACT

Provided herein are compositions which are useful as electrolytes and/or catholytes in an electrochemical cell that includes a solid-state separator and a lithium-metal anode.

### FIELD

The present disclosure concerns solid-state rechargeable batteries and electrolytes and catholytes used in solid-state rechargeable batteries.

### BACKGROUND

Solid-state rechargeable batteries, which include a lithium-metal anode, require a specific kind of solid-state electrolyte separator positioned between the cathode and anode. The solid-state electrolyte separator must be a solid, also stable in contact with lithium metal, and able to conduct Li⁺ ions but not electrons at appreciable rates. Liquid-based rechargeable batteries that include carbon-based (e.g., graphite) anodes (i.e., negative electrode) don't use such solid-state electrolytes. Instead, between the cathode and anode in these liquid-based rechargeable batteries is a liquid electrolyte. These liquid electrolytes are typically carbonate-based in that they use carbonate solvents, such as diethyl carbonate or dimethyl carbonate, to dissolve a lithium-salt, such as LiPF₆.

In some publications, ethylene sulfite was used as an additive to carbonate-based solvent electrolytes. These compositions were optimized for graphite-based anodes. See, for example, https://doi.org/10.1149/1.1391630; https://doi.org/10.1021/la015553h; https://doi.org/10.1016/j.jpowsour.2010.08.092; https://doi.org/10.1016/j.jpowsour.2005.02.007; and https://doi.org/10.1039/C5CP04221F. There exists a need for new electrolytes and catholytes which are compatible with solid-state battery electrolyte separators.

### SUMMARY

In one embodiment, provided herein is a catholyte solution including a lithium salt; and at least two aprotic C₃₋₁₀ heterocyclic molecules, each independently, in each instance, comprising at least one sulfur (S) ring atom and optionally substituted with 1 to 6 substituents.

In a second embodiment, provided herein is a catholyte solution comprising: a lithium salt; an aprotic C₃₋₁₀ heterocyclic molecule comprising at least one sulfur (S) ring atom and optionally substituted with 1 to 6 substituents.

In a third embodiment, provided herein is an electrochemical cell including: a positive electrode, a lithium-metal negative electrode, a solid-state electrolyte comprising a lithium-stuffed garnet, and a catholyte, wherein the catholyte includes: a lithium salt; and at least two C₃₋₁₀ heterocyclic molecules, each independently, in each instance, including at least one sulfur (S) ring atom and optionally substituted with 1 to 6 substituents.

In a fourth embodiment, provided herein is an electrochemical cell including: a positive electrode, a lithium-metal negative electrode, a solid-state electrolyte comprising a lithium-stuffed garnet, and a catholyte, wherein the catholyte includes: a lithium salt; and an aprotic C₃₋₁₀ heterocyclic molecule comprising at least one sulfur (S) ring atom and optionally substituted with 1 to 6 substituents.

In a fifth embodiment, provided herein is a process for making a catholyte solution, comprising mixing a lithium salt and at least two C₃₋₁₀ heterocyclic molecules, each independently, in each instance, comprising at least one sulfur (S) ring atom and optionally substituted with 1 to 6 substituents.

In a sixth embodiment, provided herein is a process for making a catholyte solution, comprising mixing a lithium salt and an aprotic C₃₋₁₀ heterocyclic molecule comprising at least one sulfur (S) ring atom and optionally substituted with 1 to 6 substituents.

In a seventh embodiment, provided herein is a process for making an electrochemical cell, including: providing a catholyte in a positive electrode, the catholyte comprising a lithium salt; and at least two C₃₋₁₀ heterocyclic molecules, each independently, in each instance, comprising at least one sulfur (S) ring atom and optionally substituted with 1 to 6 substituents; and contacting a solid-state electrolyte separator that includes lithium-stuffed garnet to the positive electrode.

In an eight embodiment, provided herein is a process for making an electrochemical cell, including: providing a catholyte in a positive electrode, the catholyte comprising a lithium salt; and an aprotic C₃₋₁₀ heterocyclic molecule comprising at least one sulfur (S) ring atom and optionally substituted with 1 to 6 substituents; and contacting a solid-state electrolyte separator that includes lithium-stuffed garnet to the positive electrode.

In a ninth embodiment, provided herein is a catholyte solution comprising: a lithium salt; and at least two aprotic C₃₋₁₀ heterocyclic molecules, each independently, in each instance, comprising at least one sulfur (S) ring atom and optionally substituted with 1 to 6 substituents, wherein the at least one C₃₋₁₀ heterocyclic molecule is selected from the group consisting of ethylene sulfite; 4-methyl-1,3,2-dioxathiolane 2-oxide; 1,3-propane sultone; sulfolane; thiophene; thiazole; 1,2-oxathiolane; thiepine; 1,4-thiazepine; 6-H-1,2,5-thiadiazine; 2H,6H-1,5,2-dithiazine; methylene methanedisulfonate; ethylene sulfate; thiopyran; thiocine, derivatives thereof, and combinations thereof.

In a tenth embodiment, provided herein is a rechargeable battery comprising a catholyte disclosed herein.

In an eleventh embodiment, provided herein is an electric vehicle comprising a rechargeable battery disclosed herein.

### BRIEF DESCRIPTIONS OF THE DRAWINGS

FIG. 1 is a plot of C-rate as a function of cycle state of charge.

FIG. 2 is a plot of state of charge (SOC) as function of cycle time (seconds).

FIG. 3 is a plot of Median charge area-specific direct current resistance (ASRDC) (Ω-cm²) for two catholytes: a 70:30 by volume (v/v) mixture of ethylene sulfite (ESI) and sulfolane (SLF) with 1.4 M LiPF₆ (labeled as 70:30 ESI:SLF); and a 45:55 by volume (v/v) mixture of ethylene carbonate and sulfolane with 1.4 M LiPF₆ (labeled as ECS45.4). Herein, the “.4” in “ECS45.4” refers to the 1.4M concentration of Li⁺ ions. The “ECS45” refers to a 45:55 v/v ratio of ethylene carbonate to sulfolane.

FIG. 4 is a plot of SOC (%) as a function of run time (seconds).

FIG. 5 is a plot of active mass-specific discharge capacity (mAh/g) for five catholyte mixtures: (a) 0.5 weight % ethylene sulfite; (b) 1 weight % ethylene sulfite; (c) 2 weight % ethylene sulfite; (d) 4 weight % ethylene sulfite; and (e) 8 weight % ethylene sulfite.

FIG. 6 is a plot of median charge area-specific resistance (ASR, Ωcm²) direct current for five catholyte mixtures: (a) 0.5 weight % ethylene sulfite; (b) 1 weight % ethylene sulfite; (c) 2 weight % ethylene sulfite; (d) 4 weight % ethylene sulfite; and (e) 8 weight % ethylene sulfite.

FIG. 7 is a plot of median charge area-specific resistance (ASR, Ωcm²), measured in direct current, for two catholyte mixtures: (a) 1.4M LiPF₆/ESS; and (b) ECS45.4. Herein, ESS refers to the combination of ethylene sulfite and sulfolane. Herein, ECS refers to the combination of ethylene carbonate and sulfolane.

FIG. 8 is a plot (top) of active mass-specific discharge capacity (mAh/g) as a function of cumulative cycle index for two catholyte mixtures: (a) 1.4M LiPF₆/ESS; and (b) ECS45.4. FIG. 8 is also a plot (bottom) of median charge area-specific resistance (ASR, Ωcm²) direct current for as a function of cumulative cycle index for two catholyte mixtures: (a) 1.4M LiPF6/ESS; and (b) ECS45.4.

FIG. 9 shows the time to 80% SOC (min) for two electrochemical cells that used catholytes with different ratios of ethylene sulfite and sulfolane, in a 4C fast charge assay at 25° C. These results relate to Example 2, herein. These results are described in Example 2, herein.

FIG. 10 shows the time to 80% SOC (min) for two electrochemical cells that used catholytes, one of which includes a third cosolvent-methyl acetate (labeled MA), in a 4C fast charge assay at 25° C. These results are described in Example 2, herein.

FIG. 11 shows the time to 80% SOC (min) for two catholytes, one of which includes a 70:30 volume ratio of ethylene sulfite to sulfolane with 1.4 M LiBF_{4;} and the other of which includes 1.2 M 10% LiFSi, in a 4C fast charge assay at 25° C. These results are described in Example 2, herein.

FIG. 12 shows the results of a one-month ASR measurement for a catholyte molarity skew of 0.5 M to 5 M. These results relate to Example 3, herein.

### DETAILED DESCRIPTION

The following description is presented to enable one of ordinary skill in the art to make and use the instant disclosure and to incorporate it in the context of particular applications. Various modifications, as well as a variety of uses in different applications will be readily apparent to those skilled in the art, and the general principles defined herein may be applied to a wide range of embodiments. Thus, the instant disclosure is not intended to be limited to the embodiments presented, but is to be accorded the widest scope consistent with the principles and novel features disclosed herein.

In the following detailed description, numerous specific details are set forth in order to provide a more thorough understanding of the present disclosure. However, it will be apparent to one skilled in the art that the disclosures herein may be practiced without necessarily being limited to these specific details.

All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Set forth herein are catholytes that include solvents or additives such as ethylene sulfite and sulfolane. In some embodiments, ethylene sulfite, sulfolane, or both, are used as additives. As additives, ethylene sulfite, sulfolane, or both, are present at less than 10% w/w, and in some embodiments less than 9% w/w; less than 8% w/w; less than 7% w/w; less than 6% w/w; less than 5% w/w; less than 4% w/w; less than 3% w/w; less than 2% w/w; less than 1% w/w; or less than 0.5% w/w. As solvents, ethylene sulfite, sulfolane, or both, are present at greater than 10% w/w.

In some embodiments, the % w/w is calculated with respect to the weight of the cathode. In some other embodiments, and unless specified otherwise, the % w/w is calculated with respect to the weight of the catholyte which is introduced into the cathode. Unless specified otherwise, % w/w is calculated with respect to the weight of the catholyte which is introduced into the cathode.

The catholytes, herein, when used in lithium rechargeable batteries with a lithium-stuffed garnet solid-state electrolyte separator, improve high voltage stability and reduce charge transfer at the lithium-stuffed garnet interface. Charge transfer at the lithium-stuffed garnet interface may result in an increase area-specific resistance (ASR). In some embodiments, including any of the foregoing, these catholytes allow for fast charging to 80% capacity within 15 minutes in a cathode with high energy density. In certain embodiments, including any of the foregoing, a cathode with high energy density is a cathode with volumetric energy density of 2000 Wh/L. In some embodiments, including any of the foregoing, these catholytes demonstrate high continuous discharge capacity and pulsed power at −30° C. In some embodiments, including any of the foregoing, these catholytes improve calendar life (e.g., calendar life performance at 4.4V and 60° C.). In some embodiments, including any of the foregoing, the catholytes herein have an improved accelerated storage test at 4.4 V and 60° C.

In some embodiments, set forth herein is a solution, wherein the solution is an electrolyte that includes ethylene sulfite, sulfolane, and lithium salt. Herein ethylene sulfite is synonymous with 1,3,2-dioxathiolan-2-oxide, cyclic ethylene sulfite, ES, and glycol sulfite.

In some embodiments, ethylene sulfite is mixed with sulfolane to provide a deep eutectic solution. The deep eutectic solution, in some embodiments, has its freezing point depressed to as low as −50° C.

In some embodiments, the solution comprises ethylene carbonate and sulfolane (ECS). Some known combinations of ECS have an insufficient low temperature conductivity to perform well at low temperature. By replacing ethylene carbonate with ethylene sulfite, and optionally by using coated cathode active material improves, calendar life may be improved by a couple orders of magnitude. By replacing ethylene carbonate with ethylene sulfite, and optionally by using coated cathode active material, low temperature performance (e.g., low temperature power) may be improved.

### Definitions

As used herein, the term “about,” when qualifying a number, e.g., about 15% w/w, refers to the number qualified and optionally the numbers included in a range about that qualified number that includes +10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, the term “ECS,” is an acronym for a mixture or solution of ethylene carbonate and sulfolane.

As used herein the phrase “solid separator” refers to a Li⁺ ion-conducting material that is substantially insulating to electrons (e.g., the lithium-ion conductivity is at least 10³ times, and often 10⁶ times, greater than the electron conductivity), and which acts as a physical barrier or spacer between the positive and negative electrodes in an electrochemical cell.

As used herein, area-specific resistance (ASR) is measured by electrochemical cycling using an Arbin, Maccor, or Biologic instrument unless otherwise specified to the contrary.

As used herein, ionic conductivity is measured by electrical impedance spectroscopy methods known in the art.

As used herein, the phrase “deep eutectic solution,” is a solution or mixture of two or more chemicals that has a freezing point depressed by at least 30° C. compared to the lowest freezing point component of the deep eutectic solution. For example, if one chemical had a freezing point of −30° C. and another chemical had a freezing point of −60° C., and the 50:50 v/v mixture of these chemicals had a freezing point of −90° C., then the mixture would be considered a deep eutectic solution.

As used herein, the phrase “film” or “thin film” refers to a thin membrane of less than 0.5 mm in thickness and greater than 10 nm in thickness. A thin film is also greater than 5 mm in a lateral dimension. A “film” or “thin-film” may be produced by a continuous process such as tape-casting, slip casting, or screen-printing.

As used herein, the phrase “film thickness” refers to the distance, or median measured distance, between the top and bottom faces of a film. As used herein, the top and bottom faces refer to the sides of the film having the largest geometric surface area, wherein the geometric surface area is calculated by multiplying the face length by its width. As used herein, thickness is measured by cross-sectional scanning electron microscopy.

As used herein, “binder” refers to a polymer with the capability to increase the adhesion and/or cohesion of material, such as the solids in a green tape. Suitable binders may include, but are not limited to, PVDF, PVDF-HFP, SBR, and ethylene alpha-olefin copolymer. A “binder” refers to a material that assists in the adhesion of another material. For example, as used herein, polyvinyl butyral is a binder because it is useful for adhering garnet materials. Other binders may include polycarbonates. Other binders may include poly acrylates and poly methacrylates. These examples of binders are not limiting as to the entire scope of binders contemplated here but merely serve as examples. Binders useful in the present disclosure include, but are not limited to, polypropylene (PP), polyethylene, atactic polypropylene (aPP), isotactic polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), polyethylene-co-poly(methylene cyclopentane) (PE-co-PMCP), poly(methyl methacrylate) (PMMA), acrylics, polyvinylacetacetal resin, [symbol] polyvinyl butyral resin, PVB, stereoblock polypropylenes, polypropylene polymethylpentene copolymer, polyethylene oxide (PEO), PEO block copolymers, silicone, polyacrylonitrile (PAN), polyvinyl chloride (PVC), polyvinyl pyrrolidone (PVP), polyethylene oxide poly(allyl glycidyl ether) PEO-AGE, polyethylene oxide 2-methoxy ethoxy ethyl glycidyl ether (PEO-MEEGE), [symbol] polyethylene oxide 2-methoxyethoxyethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), nitrile rubber (NPR), polybutadiene polymer, polybutadiene rubber (PB), polyisobutadiene rubber (PIB), polyolefin, alpha-polyolefin, ethylene alpha-polyolefin, polyisoprene rubber (PI), polychloroprene rubber (CR), acrylonitrile-butadiene rubber (NBR), and polyethyl acrylate (PEA), and the like.

As used herein, the phrase “Lewis acid” refers to a molecule or functional group that has a tendency to accept electrons (or electron density) from basic molecules. Examples of Lewis acids include, but are not limited to, tris(trimethysilyl) phosphite (TTSPi), tris(trimethysilyl) phosphate (TTSPa), tris(2,2,2-trifluoroethyl) phosphite, tris(2,2,2-trifluoroethyl) phosphate (TTFEP), tris(2,2,2-trifluoroethyl) borate (TTFEB), trimethoxyboroxine (C₃H₉B₃O₆, TMOBX), triallyl phosphate (TAP), tris(trimethylsilyl) borate (TMSB), tris(pentafluorophenyl) borane (TPFPB), and combinations thereof.

Examples of non-Lewis acids used herein include: vinylene carbonate (VC), vinyl ethylene carbonate (VEC), methylene methane disulfonate (MMDS), ethylene sulfate, 1,3 propylene sulfate, prop-1-ene-1,3 sultone (PES), propylene sulfite, 1,4 butane sultone, fluoroethylene carbonate (FEC), LiTFSi, LiBOB, 3-sulfolene, succinonitrile, glutaronitrile, trimethylene sulfate (TMS), and combinations thereof.

As used herein, the term “alkyl” by itself or as part of another substituent refers to a saturated branched or straight-chain monovalent terminal group, or divalent bridging group, hydrocarbon radical derived by the removal of at least one hydrogen atom from a single carbon atom of a parent alkane. Alkyl groups of interest include, but are not limited to, methyl; ethyl, [symbol] n-propyl, i-propyl, n-butyl, i-butyl, t-butyl. In some embodiments, an alkyl group includes from 1 to 20 carbon atoms. In some embodiments, an alkyl group includes from 1 to 10carbon atoms. In certain embodiments, an alkyl group includes from 1 to 6 carbon atoms, such as from 1 to 4 carbon atoms. This term includes, by way of example, linear and branched hydrocarbyl groups such as methyl (CH₃—), ethyl (CH₃CH₂—), n-propyl (CH₃CH₂CH₂—), isopropyl ((CH₃)₂CH—), [symbol] n-butyl (CH₃CH₂CH₂CH₂—), isobutyl ((CH₃)₂CHCH₂—), sec-butyl ((CH₃)(CH₃CH₂)CH—), t-butyl ((CH₃)₃C—), n-pentyl (CH₃CH₂CH₂CH₂CH₂—), and neopentyl ((CH₃)₃CCH₂—). Alkyl substituents may be substituted with 1 to 6 substituents which are not further substituted.

“Heteroalkyl” refers to a straight-or branched-chain alkyl group preferably having from 2 to 14 carbons, more preferably 2 to 10 carbons in the chain, one or more of which has been replaced by a heteroatom selected from S, O, P and N. Exemplary heteroalkyls include alkyl ethers (i.e., alkoxyl), secondary and tertiary alkyl amines, amides, alkyl sulfides (i.e., thiol), and the like. Heteroalkyl substituents may be substituted with 1 to 6 substituents which are not further substituted. The group may be a monovalent terminal group or a divalent bridging group.

As used herein, the phrase “C₃₋₁₀ heterocyclic molecule comprising at least one sulfur (S) ring atom” refers to a cyclic alkyl, alkenyl, or alkynyl ring in which at least one carbon atom is replaced by a sulfur (S) atom. A C₃₋₁₀ heterocyclic molecule is a molecule which includes 3, 4, 5, 6, 7, 8, 9, or 10 carbon atoms in a continuous ring structure.

As used herein, the phrase “optionally substituted with 1 to 6 substituents,” refers to the condition where a group may or may not have substituents. When substituents are present, only 1, 2, 3, 4, 5, or 6 substituents are present. Substituents include, but are not limited to, polyethylene glycol (PEG), ═O, SO₂, —CF₃, —CH₂F, CHF₂, —NO₂, —NO₃, —NH₃, —CH₃, PO₄, PO₃, BO₃, —CN, F, Cl, Br, I, and combinations thereof. Herein, these substituents are not further substituted unless explicitly stated so. Herein, these substituents are not protic unless explicitly stated so.

As used herein, the phrase “C₃₋₁₀ heterocyclic molecule comprising at least one sulfur (S) ring atom and one oxygen (O) ring atom” refers to a cyclic alkyl, alkenyl, or alkynyl ring in which at least one carbon atom is replaced by a sulfur (S) atom and at least one carbon atom is replaced by an oxygen (O) atom. A C₃₋₁₀ heterocyclic molecule is a molecule which includes 3, 4, 5, 6, 7, 8, 9, or 10 carbon atoms in a continuous ring structure.

As used herein, the phrases “electrochemical cell” or “battery cell” shall mean a single cell including a positive electrode and a negative electrode, which have ionic communication between the two using an electrolyte. In some embodiments, the same battery cell includes multiple positive electrodes and/or multiple negative electrodes enclosed in one container.

As used herein the phrase “electrochemical stack,” refers to one or more units which each include at least a negative electrode (e.g., Li, LiC₆), a positive electrode (e.g., FeF₃, NiFₓ wherein x is 2 or 3, nickel-cobalt aluminum oxide NCA, lithium iron phosphate (LFP), LiNiₓMn_{y}Co₂O₂, [NMC] or LiNiₓAl_{y}Co₂O₂ [NCA], wherein x+y+z=1; and wherein 0≤x≤1; 0≤y≤1; and 0≤z≤1), optionally combined with a solid-state electrolyte or a gel electrolyte), and a solid-state electrolyte (e.g., an oxide electrolyte set forth herein such as a lithium-stuffed garnet (Li₇La₃Zr₂O₁₂)) between and in contact with the positive and negative electrodes. In some embodiments, including any of the foregoing, between the solid-state electrolyte and the positive electrode, there is an additional layer comprising a compliant material (e.g., gel electrolyte). An electrochemical stack may include one of these aforementioned units. An electrochemical stack may include several of these aforementioned units arranged in electrical communication (e.g., serial or parallel electrical connection). In some embodiments, including any of the foregoing, when the electrochemical stack includes several units, the units are layered or laminated together in a column. In some embodiments, including any of the foregoing, when the electrochemical stack includes several units, the units are layered or laminated together in an array. In some embodiments, including any of the foregoing, when the electrochemical stack includes several units, the stacks are arranged such that one negative electrode is shared with two or more positive electrodes. Alternatively, in some embodiments, including any of the foregoing, when the electrochemical stack includes several units, the stacks are arranged such that one positive electrode is shared with two or more negative electrodes. Unless specified otherwise, an electrochemical stack includes one positive electrode, one solid-state electrolyte, and one negative electrode, and optionally includes a bonding layer between the positive electrode and the solid electrolyte.

As used here, the phrase “positive electrode,” refers to the electrode in a secondary battery towards which positive ions, e.g., Li⁺, conduct, flow, or move during discharge of the battery.

As used herein, the phrase “negative electrode” refers to the electrode in a secondary battery from where positive ions, e.g., Li⁺ flow, or move during discharge of the battery. A negative electrode that includes lithium metal is referred to herein as a lithium metal negative electrode.

In a battery comprised of a Li-metal electrode and a conversion chemistry, intercalation chemistry, or combination of conversion/intercalation chemistry-including electrode (i.e., cathode active material), the electrode having the conversion chemistry, intercalation chemistry, or combination conversion/intercalation chemistry material is referred to as the positive electrode. In some common usages, cathode is used in place of positive electrode, and anode is used in place of negative electrode. When a Li-secondary battery is charged, Li ions move from the positive electrode (e.g., NiFₓ, NMC, NCA) towards the negative electrode (e.g., Li-metal). When a Li-secondary battery is discharged, Li ions move towards the positive electrode and from the negative electrode.

As used herein, the phrase “positive electrode terminal,” refers to an electrical connection to the positive electrode. A positive electrode terminal may also be referred to as a positive electrode current collector.

As used herein, the phrase “negative electrode terminal,” refers to an electrical connection to the negative electrode. A negative electrode terminal may also be referred to as a negative electrode current collector.

As used herein the phrase “cathode active material,” refers to a material which can intercalate lithium ions or react with lithium ions in a reversible manner. Examples include LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al₂O₂, wherein x+y+z=1, and 0≤x≤1, 0≤y≤1, and 0≤z≤1. In these formula, x, y, and z are chosen so that the formula is charge neutral.

As used herein the phrase “solid-state cathode” refers to a cathode which does not include a liquid-phase electrolyte. As used herein, the terms “cathode” and “anode” refer to the electrodes of a battery. The cathode and anode are often referred to in the relevant field as the positive electrode and negative electrode, respectively.

As used herein, the term “electrolyte,” refers to a material that allows ions, e.g., Li⁺, to migrate therethrough, but which does not allow electrons to conduct therethrough. An electrolyte is ionically conductive and electrically insulating material, Electrolytes are useful for electrically insulating the cathode and anode of a secondary battery while allowing ions, e.g., Li⁺, to transmit through the electrolyte.

As used herein, the phrases “gel electrolyte,” unless specified otherwise, refers to a suitable Li⁺ ion conducting gel or liquid-based electrolyte, for example, those set forth in U.S. Pat. No. 5,296,318, entitled RECHARGEABLE LITHIUM INTERCALATION BATTERY WITH HYBRID POLYMERIC ELECTROLYTE, which is incorporated by reference in its entirety for all purposes. A gel electrolyte has lithium-ion conductivity of greater than 10⁻⁵ S/cm at room temperature, a lithium transference number between 0.05-0.95, and a storage modulus greater than the loss modulus at some temperature. A gel may comprise a polymer matrix, a solvent that gels the polymer, and a lithium containing salt that is at least partly dissociated into Li⁺ ions and anions. Herein, in some examples, the gel electrolyte is used as the bonding layer.

As used herein, the term “catholyte,” refers to a liquid or gel lithium-ion conductor that is intimately mixed with, or surrounded by, a cathode (i.e., positive electrode) active material. A liquid electrolyte, when mixed with a cathode, is a catholyte.

As used here, the phrase “solid-state electrolyte separator,” or “solid-state separator,” or “solid-state separator,” is used interchangeably with the phrase “solid separator” refers to a material which does not include carbon and which conducts atomic ions (e.g., Li⁺) but does not conduct electrons. A solid-state electrolyte separator is a solid material suitable for electrically isolating the positive and negative electrodes of a lithium secondary battery while also providing a conduction pathway for lithium ions. Example inorganic solid-state electrolytes include oxide electrolytes and sulfide electrolytes, which are further defined below. Non-limiting examples of sulfide electrolytes are found, for example, in U.S. Pat. No. 9,172,114, which issued Oct. 27, 2015, and also in US Patent Application Publication No. 2017-0162901 A1, which published Jun. 8, 2017, the entire contents of which are herein incorporated by reference in its entirety for all purposes. Non-limiting example oxide electrolytes are found, for example, in US Patent Application Publication No. 2015-0200420 A1, which published Jul. 16, 2015, the entire contents of which are herein incorporated by reference in its entirety for all purposes. In some examples, the inorganic solid-state electrolyte also includes a polymer and is referred to as a composite electrolyte. Composite electrolytes are found for example in U.S. Pat. No. 9,666,870, the entire contents of which are herein incorporated by reference in its entirety for all purposes.

As used herein, the terms “separator,” and “Li⁺ ion-conducting separator,” are used interchangeably with separator being a short-hand reference for Li⁺ ion-conducting separator, unless specified otherwise explicitly. As used herein the phrase “solid-state electrolyte separator” refers to a Li⁺ ion-conducting material that is substantially insulating to electrons (e.g., the lithium-ion conductivity is at least 10³ times, and often 10⁶ times, greater than the electron conductivity), and which acts as a physical barrier or spacer between the positive and negative electrodes in an electrochemical cell.

Unless explicitly specified to the contrary, a separator as used herein is stable when in contact with lithium metal.

As used herein, the phrase “thickness” or “film thickness” refers to the distance, or median measured distance between the top and bottom faces or surfaces. As used herein, the top and bottom faces refer to the sides having the largest geometric surface area.

As used herein, “thin” means, when qualifying a solid-state electrolyte, a thickness dimension less than 200 μm, sometimes less than 100 μm and in some cases between 0.1 and 60 μm, and in other cases between about 10 nm to about 100 μm; in other cases, about 1 μm, 10 μm, or 50 μm in thickness.

As used herein, “sintered thin film,” refers to a thin film that has been sintered, e.g., heated above 1000° C. to densify its structure without changing its chemical composition.

As used herein, the phrase “lithium stuffed garnet” refers to oxides that are characterized by a crystal structure related to a garnet crystal structure. Example lithium-stuffed garnet electrolytes include those electrolytes set forth in US Patent Application Publication No. 2015/0099190, published on Apr. 9, 2015, entitled GARNET MATERIALS FOR LI SECONDARY BATTERIES AND METHODS OF MAKING AND USING GARNET MATERIALS, and filed Oct. 7, 2014, the contents of which are incorporated by reference in their entirety. Li-stuffed garnets generally having a composition according to Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}ND_{E}O_{F}, wherein 4<A<8.5, 1.5<B<4, 0≤C≤2.5, 0≤D≤2.5; 0≤E<2.3, 10<F<13, and M′ and M″ are each, independently in each instance selected from Al, Mo, W, Ga, Gd, Y, Nb, Sb, Ca, Ba, Sr, Ce, Hf, Rb, or Ta, or LiₐLa_{b}Zr_{c}Al_{d}Me″ₑO_{f}, wherein 5<a<8.5; 2<b<4; 0<c≤2.5; 0≤d<2; 0≤e<2, and 10<f<13 and Me″ is a metal selected from Nb, Ta, V, W, Mo, or Sb and as otherwise described in U.S. Patent Application Publication No. U.S. 2015/0099190. In some embodiments, A may be about 6.0 or about 6.1 or about 6.2 or about 6.3 or about 6.4 or about 6.5 or about 6.6 or about 6.7 or about 6.8 or about 6.9 or about 7.0 or about 7.1 or about 7.2 or about 7.3 or about 7.4. In some embodiments, B may be about 2.8 or about 2.9 or about 3.0 or about 3.1 or about 3.2. In some embodiments, C may be about 0 or about 0.1 or about 0.2 or about 0.3 or about 0.4 or about 0.5 or about 0.6 or about 0.7 or about 0.8 or about 0.9 or about 1.0 or about 1.1 or about 1.2 or about 1.3 or about 1.4 or about 1.5 or about 1.6 or about 1.7 or about 1.8 or about 1.9 or about 2.0. In some embodiments D may be about 0 or about 0.1 or about 0.2 or about 0.3 or about 0.4 or about 0.5 or about 0.6 or about 0.7 or about 0.8 or about 0.9 or about 1.0 or about 1.1 or about 1.2 or about 1.3 or about 1.4 or about 1.5 or about 1.6 or about 1.7 or about 1.8 or about 1.9 or about 2.0. In some embodiments, E may be about 1.4 or about 1.5 or about 1.6 or about 1.7 or about 1.8 or about 1.9 or about 2.0 or about 2.1 or about 2.2. In some embodiments, F may be about 11.0 or about 11.1 or about 11.2 or about 11.3 or about 11.4 or about 11.5 or about 11.6 or about 11.7 or about 11.8 or about 11.9 or about 12.0 or about 12.1 or about 12.2 or about 12.3 or about 12.4 or about 12.5 or about 12.6 or about 12.7 or about 12.8 or about 12.9 or about 13.0. Herein, the subscript values and coefficient values are selected so the compound is charge neutral unless stated otherwise to the contrary. As used herein, lithium-stuffed garnets, and garnets, generally, include, but are not limited to, Li_{7.0}La₃(Zrₜ₁+Nbₜ₂+Taₜ₃)O₁₂+0.35Al₂O₃; wherein (subscripts t1+t2+t3=subscript 2) so that the La:(Zr/Nb/Ta) ratio is 3:2. Also, garnets used herein include, but are not limited to, LiₓLa₃Zr₂O_{F}+yAl₂O₃, wherein x ranges from 5.5 to 9; and y ranges from 0 to 1. In these embodiments, subscripts x, y, and F are selected so that the garnet is charge neutral. In some embodiments x is 7 and y is 1.0. In some embodiments, x is 5 and y is 1.0. In some embodiments, x is 6 and y is 1.0. In some embodiments, x is 8 and y is 1.0. In some embodiments, x is 9 and y is 1.0. In some embodiments x is 7 and y is 0.35. In some embodiments, x is 5 and y is 0.35. In some embodiments, x is 6 and y is 0.35. In some embodiments, x is 8 and y is 0.35. In some embodiments, x is 9 and y is 0.35. In some embodiments x is 7 and y is 0.7. In some embodiments, x is 5 and y is 0.7. In some embodiments, x is 6 and y is 0.7. In some embodiments, x is 8 and y is 0.7. In some embodiments, x is 9 and y is 0.7. In some embodiments x is 7 and y is 0.75. In some embodiments, x is 5 and y is 0.75. In some embodiments, x is 6 and y is 0.75. In some embodiments, x is 8 and y is 0.75. In some embodiments, x is 9 and y is 0.75. In some embodiments x is 7 and y is 0.8. In some embodiments, x is 5 and y is 0.8. In some embodiments, x is 6 and y is 0.8. In some embodiments, x is 8 and y is 0.8. In some embodiments, x is 9 and y is 0.8. In some embodiments x is 7 and y is 0.5. In some embodiments, x is 5 and y is 0.5. In some embodiments, x is 6 and y is 0.5. In some embodiments, x is 8 and y is 0.5. In some embodiments, x is 9 and y is 0.5. In some embodiments x is 7 and y is 0.4. In some embodiments, x is 5 and y is 0.4. In some embodiments, x is 6 and y is 0.4. In some embodiments, x is 8 and y is 0.4. In some embodiments, x is 9 and y is 0.4. In some embodiments x is 7 and y is 0.3. In some embodiments, x is 5 and y is 0.3. In some embodiments, x is 6 and y is 0.3. In some embodiments, x is 8 and y is 0.3. In some embodiments, x is 9 and y is 0.3. In some embodiments x is 7 and y is 0.22. In some embodiments, x is 5 and y is 0.22. In some embodiments, x is 6 and y is 0.22. In some embodiments, x is 8 and y is 0.22. In some embodiments, x is 9 and y is 0.22. Also, garnets as used herein include, but are not limited to, LiₓLa₃Zr₂O₁₂+yAl₂O₃. In one embodiment, the Li-stuffed garnet herein has a composition of Li₇Li₃Zr₂O₁₂. In another embodiment, the Li-stuffed garnet herein has a composition of Li₇Li₃Zr₂O₁₂·Al₂O₃. In yet another embodiment, the Li-stuffed garnet herein has a composition of Li₇Li₃Zr₂O₁₂·0.22Al₂O₃. In yet another embodiment, the Li-stuffed garnet herein has a composition of Li₇Li₃Zr₂O₁₂·0.35Al₂O₃. In certain other embodiments, the Li-stuffed garnet herein has a composition of Li₇Li₃Zr₂O₁₂·0.5Al₂O₃. In another embodiment, the Li-stuffed garnet herein has a composition of Li₇Li₃Zr₂O₁₂·0.75Al₂O₃.

As used herein, lithium-stuffed garnet and/or garnet does not include YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein, the phrases “garnet precursor chemicals,” “chemical precursor to a garnet-type electrolyte,” “precursors to garnet” and “garnet precursor materials” refer to chemicals which react to form a lithium stuffed garnet material described herein. These chemical precursors include, but are not limited to lithium hydroxide (e.g., LiOH), lithium oxide (e.g., Li₂O), lithium carbonate (e.g., LiCO₃), zirconium oxide (e.g., ZrO₂), zirconium hydroxide, zirconium acetate, zirconium nitrate, zirconium acetylacetonate, zirconium nitrate x-hydrate, lanthanum oxide (e.g., La₂O₃), lanthanum hydroxide (e.g., La(OH)₃), lanthanum nitrate, lanthanum acetate, lanthanum acetylacetonate, aluminum oxide (e.g., Al₂O₃), aluminum hydroxide (e.g., Al(OH)₃), aluminum (e.g., Al), aluminum nitrate (e.g., Al(NO₃)₃), aluminum nitrate nonahydrate, boehmite, gibbsite, corundum, aluminum oxyhydroxide, niobium oxide (e.g., Nb₂O₅), gallium oxide (Ga₂O₃), and tantalum oxide (e.g., Ta₂O₅). Other precursors to garnet materials may be suitable for use with the methods set forth herein.

As used herein the phrase “garnet-type electrolyte,” refers to an electrolyte that includes a lithium stuffed garnet material described herein as the Li⁺ ion conductor.

As used herein, the phrase “doped with alumina” means that Al₂O₃ is used to replace certain components of another material, e.g., a garnet. A lithium stuffed garnet that is doped with Al₂O₃ refers to garnet wherein aluminum (Al) substitutes for an element in the lithium stuffed garnet chemical formula, which may be, for example, Li or Zr.

As used herein, area-specific resistance (ASR) is measured by electrochemical cycling using an Arbin or Biologic instrument unless otherwise specified to the contrary.

### Electrochemical Cells

In one embodiment, provided herein is an electrochemical cell including: a positive electrode, a lithium-metal negative electrode, a solid-state electrolyte comprising lithium-stuffed garnet, and a catholyte, wherein the catholyte includes: a lithium salt; and at least two C₃₋₁₀ heterocyclic molecules, each independently, in each instance, including at least one sulfur (S) ring atom and optionally substituted with 1 to 6 substituents.

In another embodiment, provided herein is an electrochemical cell including: a positive electrode, a lithium-metal negative electrode, a solid-state electrolyte comprising lithium-stuffed garnet, and a catholyte, wherein the catholyte includes: a lithium salt; and at least two C₃₋₁₀ heterocyclic molecule comprising at least one sulfur (S) ring atom, each independently, in each instance, including at least one sulfur (S) ring atom and optionally substituted with 1 to 6 substituents.

In another embodiment, provided herein is an electrochemical cell including: a positive electrode, a lithium-metal negative electrode, a solid-state electrolyte comprising lithium-stuffed garnet, and a catholyte, wherein the catholyte includes: a lithium salt; and at least two C₃₋₁₀ heterocyclic molecule comprising at least one sulfur (S) ring atom and one oxygen (O) ring atom, each independently, in each instance, including at least one sulfur (S) ring atom and optionally substituted with 1 to 6 substituents.

In certain embodiments, including any of the foregoing, the substitutes are selected from polyethylene glycol (PEG), ═O, SO₂, —CF₃, —CH₂F, CHF₂, —NO₂, —NO₃, —NH₃, —CH₃, PO₄, PO₃, BO₃ and —CN.

### Catholyte Solutions

In one embodiments, including any of the foregoing, provided herein is catholyte solution which includes a lithium salt; and at least two C₃₋₁₀ heterocyclic molecules, each independently, in each instance, including at least one sulfur (S) ring atom and optionally substituted with 1 to 6 substituents.

In another embodiments, including any of the foregoing, provided herein is catholyte solution which includes a lithium salt; and at least two C₃₋₁₀ heterocyclic molecule comprising at least one sulfur (S) ring atom, each independently, in each instance, including at least one sulfur (S) ring atom and optionally substituted with 1 to 6 substituents.

In certain embodiments, including any of the foregoing, the substitutes are selected from polyethylene glycol (PEG), ═O, SO₂, —CF₃, —CH₂F, CHF₂, —NO₂, —NO₃, —NH₃, —CH₃, PO₄, PO₃, BO₃ and —CN.

In some embodiments, including any of the foregoing, the C₃₋₁₀ heterocyclic molecules is a molecule of Formula (I):

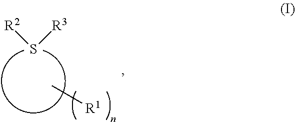

wherein R¹ is selected from the group consisting of polyethylene glycol (PEG), ═O, SO₂, —CF₃, —CH₂F, CHF₂, —NO₂, —NO₃, —NH₃, —CH₃, PO₄, PO₃, BO₃, —CN, and combinations thereof; R² is ═O or is absent; R³ is ═O or is absent; and subscript n is an integer from 0 to 8.

In some embodiments, including any of the foregoing, the C₃₋₁₀ heterocyclic molecule is a molecule of Formula (II):

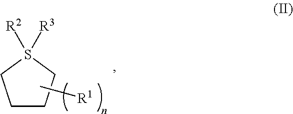

wherein R¹ is selected from the group consisting of polyethylene glycol (PEG), ═O, SO₂, —CF₃, —CH₂F, CHF₂, —NO₂, —NO₃, —NH₃, —CH₃, PO₄, PO₃, BO₃, —CN, and combinations thereof; R² is ═O or is absent; R³ is ═O or is absent; and subscript n is an integer from 0 to 8.

In some embodiments, including any of the foregoing, the C₃₋₁₀ heterocyclic molecules is a molecule of Formula

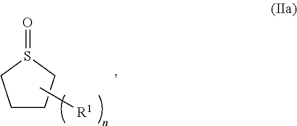

wherein R¹ is selected from the group consisting of polyethylene glycol (PEG), ═O, SO₂, —CF₃, —CH₂F, CHF₂, —NO₂, —NO₃, —NH₃, —CH₃, PO₄, PO₃, BO₃, —CN, and combinations thereof; and subscript n is an integer from 0 to 8.

In some embodiments, including any of the foregoing, the C₃₋₁₀ heterocyclic molecules is a molecule of Formula (IIb):

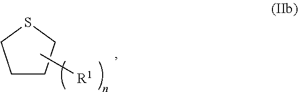

wherein R¹ is selected from the group consisting of polyethylene glycol (PEG), ═O, SO₂, —CF₃, —CH₂F, CHF₂, —NO₂, —NO₃, —NH₃, —CH₃, PO₄, PO₃, BO₃, —CN, and combinations thereof; and subscript n is an integer from 0 to 8.

In some embodiments, including any of the foregoing, the C₃₋₁₀ heterocyclic molecules are a molecule of Formula (III):

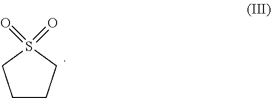

In some embodiments, including any of the foregoing, the C₃₋₁₀ heterocyclic molecules are a molecule of Formula (VII):

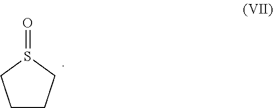

In some embodiments, including any of the foregoing, the C₃₋₁₀ heterocyclic molecules is a molecule of Formula (IV):

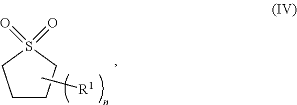

wherein R¹ is selected from the group consisting of polyethylene glycol (PEG), ═O, SO₂, —CF₃, —CH₂F, CHF₂, —NO₂, —NO₃, —NH₃, —CH₃, PO₄, PO₃, BO₃, —CN, and combinations thereof; and subscript n is an integer from 0 to 8.

In some embodiments, including any of the foregoing, the C₃₋₁₀ heterocyclic molecule comprises at least one sulfur (S) ring atom.

In some embodiments, including any of the foregoing, the C₃₋₁₀ heterocyclic molecule comprises at least one sulfur (S) ring atom and one oxygen (O) ring atom.

In some embodiments, including any of the foregoing, the C₃₋₁₀ heterocyclic molecules is a molecule of Formula (V):

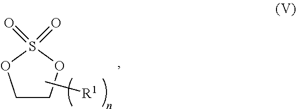

wherein R¹ is selected from the group consisting of polyethylene glycol (PEG), ═O, SO₂, —CF₃, —CH₂F, CHF₂, —NO₂, —NO₃, —NH₃, —CH₃, PO₄, PO₃, BO₃, —CN, and combinations thereof. Subscript n is an integer from 0 to 8.

In some embodiments, including any of the foregoing, the C₃₋₁₀ heterocyclic molecules are a molecule of Formula (VI):

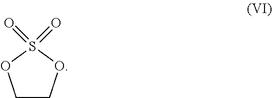

In some embodiments, including any of the foregoing, R¹ is PEG. In certain embodiments, including any of the foregoing, subscript n is 1. In certain other embodiments, including any of the foregoing, subscript n is 2. In some embodiments, including any of the foregoing, subscript n is 3. In some other embodiments, including any of the foregoing, subscript n is 4. In certain embodiments, including any of the foregoing, subscript n is 5. In yet other embodiments, including any of the foregoing, subscript n is 6. In some embodiments, including any of the foregoing, subscript n is 7. In some other embodiments, including any of the foregoing, subscript n is 8.

In certain embodiments, including any of the foregoing, subscript n is 0. In certain embodiments, including any of the foregoing, subscript n is 1. In certain other embodiments, including any of the foregoing, subscript n is 2. In some embodiments, including any of the foregoing, subscript n is 3. In some other embodiments, including any of the foregoing, subscript n is 4. In certain embodiments, including any of the foregoing, subscript n is 5. In yet other embodiments, including any of the foregoing, subscript n is 6. In some embodiments, including any of the foregoing, subscript n is 7. In some other embodiments, including any of the foregoing, subscript n is 8.

In some embodiments, including any of the foregoing, R¹ is ═O. In certain embodiments, subscript n is 1. In certain other embodiments, subscript n is 2. In some embodiments, subscript n is 3. In some other embodiments, subscript n is 4. In certain embodiments, subscript n is 5. In yet other embodiments, subscript n is 6. In some embodiments, subscript n is 7. In some other embodiments, subscript n is 8.

In some embodiments, including any of the foregoing, R¹ is SO₂. In certain embodiments, subscript n is 1. In certain other embodiments, subscript n is 2. In some embodiments, subscript n is 3. In some other embodiments, subscript n is 4. In certain embodiments, subscript n is 5. In yet other embodiments, subscript n is 6. In some embodiments, subscript n is 7. In some other embodiments, subscript n is 8.

In some embodiments, including any of the foregoing, R¹ is —CF₃. In certain embodiments, subscript n is 1. In certain other embodiments, subscript n is 2. In some embodiments, subscript n is 3. In some other embodiments, subscript n is 4. In certain embodiments, subscript n is 5. In yet other embodiments, subscript n is 6. In some embodiments, subscript n is 7. In some other embodiments, subscript n is 8.

In some embodiments, including any of the foregoing, R¹ is —CH₂F. In certain embodiments, subscript n is 1. In certain other embodiments, subscript n is 2. In some embodiments, subscript n is 3. In some other embodiments, subscript n is 4. In certain embodiments, subscript n is 5. In yet other embodiments, subscript n is 6. In some embodiments, subscript n is 7. In some other embodiments, subscript n is 8.

In some embodiments, including any of the foregoing, R¹ is CHF₂. In certain embodiments, subscript n is 1. In certain other embodiments, subscript n is 2. In some embodiments, subscript n is 3. In some other embodiments, subscript n is 4. In certain embodiments, subscript n is 5. In yet other embodiments, subscript n is 6. In some embodiments, subscript n is 7. In some other embodiments, subscript n is 8. In some embodiments, including any of the foregoing, R¹ is —NO₂.

In some embodiments, including any of the foregoing, R¹ is —NO₃. In certain embodiments, subscript n is 1. In certain other embodiments, subscript n is 2. In some embodiments, subscript n is 3. In some other embodiments, subscript n is 4. In certain embodiments, subscript n is 5. In yet other embodiments, subscript n is 6. In some embodiments, subscript n is 7. In some other embodiments, subscript n is 8. In some embodiments, including any of the foregoing, R¹ is —NH₃.

In some embodiments, including any of the foregoing, R¹ is —CH₃. In certain embodiments, subscript n is 1. In certain other embodiments, subscript n is 2. In some embodiments, subscript n is 3. In some other embodiments, subscript n is 4. In certain embodiments, subscript n is 5. In yet other embodiments, subscript n is 6. In some embodiments, subscript n is 7. In some other embodiments, subscript n is 8.

In some embodiments, including any of the foregoing, R¹ is PO₄. In certain embodiments, subscript n is 1. In certain other embodiments, subscript n is 2. In some embodiments, subscript n is 3. In some other embodiments, subscript n is 4. In certain embodiments, subscript n is 5. In yet other embodiments, subscript n is 6. In some embodiments, subscript n is 7. In some other embodiments, subscript n is 8.

In some embodiments, including any of the foregoing, R¹ is PO³. In certain embodiments, subscript n is 1. In certain other embodiments, subscript n is 2. In some embodiments, subscript n is 3. In some other embodiments, subscript n is 4. In certain embodiments, subscript n is 5. In yet other embodiments, subscript n is 6. In some embodiments, subscript n is 7. In some other embodiments, subscript n is 8.

In some embodiments, including any of the foregoing, R¹ is BO₃. In certain embodiments, subscript n is 1. In certain other embodiments, subscript n is 2. In some embodiments, subscript n is 3. In some other embodiments, subscript n is 4. In certain embodiments, subscript n is 5. In yet other embodiments, subscript n is 6. In some embodiments, subscript n is 7. In some other embodiments, subscript n is 8.

In some embodiments, including any of the foregoing, R¹ is —CN. In certain embodiments, subscript n is 1. In certain other embodiments, subscript n is 2. In some embodiments, subscript n is 3. In some other embodiments, subscript n is 4. In certain embodiments, subscript n is 5. In yet other embodiments, subscript n is 6. In some embodiments, subscript n is 7. In some other embodiments, subscript n is 8.

In some embodiments, including any of the foregoing, at least one C₃₋₁₀ heterocyclic molecule is selected from the group consisting of ethylene sulfite, propylene glycol sulfite, sulfolane; 1,3-propane sultone; sulfolane; thiophene, thiazole, 1,2-oxathiolane, thiepine, 1,4-thiazepine, 6-H-1,2,5-thiadiazine, 2H,6H-1,5,2-dithiazine, thiopyran, thiepine, thiocine, derivatives thereof, and combinations thereof.

In some embodiments, including any of the foregoing, at least one C₃₋₁₀ heterocyclic molecule is selected from ethylene sulfite.

In some embodiments, including any of the foregoing, at least one C₃₋₁₀ heterocyclic molecule is selected from propylene glycol sulfite.

In some embodiments, including any of the foregoing, at least one C₃₋₁₀ heterocyclic molecule is selected from sulfolane.

In some embodiments, including any of the foregoing, at least one C₃₋₁₀ heterocyclic molecule is selected from 1,3-propane sultone.

In some embodiments, including any of the foregoing, at least one C₃₋₁₀ heterocyclic molecule is selected from sulfolane.

In some embodiments, including any of the foregoing, at least one C₃₋₁₀ heterocyclic molecule is selected from thiophene.

In some embodiments, including any of the foregoing, at least one C₃₋₁₀ heterocyclic molecule is selected from thiazole.

In some embodiments, including any of the foregoing, at least one C₃₋₁₀ heterocyclic molecule is selected from 1,2-oxathiolane.

In some embodiments, including any of the foregoing, at least one C₃₋₁₀ heterocyclic molecule is selected from thiepine.

In some embodiments, including any of the foregoing, at least one C₃₋₁₀ heterocyclic molecule is selected from 1,4-thiazepine.

In some embodiments, including any of the foregoing, at least one C₃₋₁₀ heterocyclic molecule is selected from 6-H-1,2,5-thiadiazine.

In some embodiments, including any of the foregoing, at least one C₃₋₁₀ heterocyclic molecule is selected from 2H,6H-1,5,2-dithiazine.

In some embodiments, including any of the foregoing, at least one C₃₋₁₀ heterocyclic molecule is selected from thiopyran.

In some embodiments, including any of the foregoing, at least one C₃₋₁₀ heterocyclic molecule is selected from thiepine.

In some embodiments, including any of the foregoing, at least one C₃₋₁₀ heterocyclic molecule is selected from thiocine.

In some embodiments, including any of the foregoing, at least one C₃₋₁₀ heterocyclic molecule is selected from the group consisting of ethylene sulfite and propylene glycol sulfite.

In some embodiments, including any of the foregoing, the derivatives of the at least one C₃₋₁₀ heterocyclic molecule includes derivative which include —CH₃, —CF₃, or F substituents.

In some embodiments, including any of the foregoing, the solid-state electrolyte is a thin film.

In some embodiments, including any of the foregoing, the solid-state electrolyte is a sintered thin film.

In some embodiments, including any of the foregoing, the solid-state electrolyte is a sintered thin film comprising lithium-stuffed garnet.

In some embodiments, including any of the foregoing, the lithium salt is selected from the group consisting of LiPF₆, Lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiI, and combinations thereof.

In some embodiments, including any of the foregoing, the LIPF₆ formulations include 30:70 sulfolane:ethylene sulfite v/v+1.4M LiPF₆.

In some embodiments, including any of the foregoing, the LiBF₄ formulations include 30:70 sulfolane:ethylene sulfite v/v+1.4M LiBF₄.

In some embodiments, including any of the foregoing, a catholyte includes 30:70 sulfolane:ethylene sulfite v/v+1.4M LiPF₆.

In some embodiments, including any of the foregoing, a catholyte includes 30:70 sulfolane:ethylene sulfite v/v+1.4M LiPF₆.

In some embodiments, including any of the foregoing, a catholyte includes 30:70 sulfolane:ethylene sulfite v/v+1.4M LiBF₄.

In some embodiments, including any of the foregoing, a catholyte includes 30:70 sulfolane:ethylene sulfite v/v+1.4M LiPF₆.

In some embodiments, including any of the foregoing, the lithium salt is present at a concentration of about 0.5 M to about 2.5 M. In some other embodiments, including any of the foregoing, the lithium salt is present at a concentration of about 0.5 M to about 2.0 M. In certain embodiments, the lithium salt is present at a concentration of about 0.5 M. In certain other embodiments, the lithium salt is present at a concentration of about 0.6 M. In some embodiments, the lithium salt is present at a concentration of about 0.7 M. In some other embodiments, the lithium salt is present at a concentration of about 0.8 M. In other embodiments, the lithium salt is present at a concentration of about 0.9 M. In still other embodiments, the lithium salt is present at a concentration of about 1.0 M. In certain embodiments, the lithium salt is present at a concentration of about 1.1 M. In certain embodiments, the lithium salt is present at a concentration of about 1.2 M. In certain embodiments, the lithium salt is present at a concentration of about 1.3 M. In certain embodiments, the lithium salt is present at a concentration of about 1.4 M. In certain embodiments, the lithium salt is present at a concentration of about 1.5 M. In certain embodiments, the lithium salt is present at a concentration of about 1.6 M. In certain embodiments, the lithium salt is present at a concentration of about 1.7 M. In certain embodiments, the lithium salt is present at a concentration of about 1.8 M. In certain embodiments, the lithium salt is present at a concentration of about 1.9 M. In certain embodiments, the lithium salt is present at a concentration of about 2.0 M. In certain embodiments, the lithium salt is present at a concentration of about 2.1 M. In certain embodiments, the lithium salt is present at a concentration of about 2.2 M. In certain embodiments, the lithium salt is present at a concentration of about 2.3 M. In certain embodiments, the lithium salt is present at a concentration of about 2.4 M. In certain embodiments, the lithium salt is present at a concentration of about 2.5 M. In certain embodiments, the lithium salt is present at a concentration of about 2.6 M.

In some embodiments, including any of the foregoing, the lithium salt is present at a concentration of about 0.5 M to about 5 M. In certain embodiments, the lithium salt is present at a concentration of about 0.5 M. In certain other embodiments, the lithium salt is present at a concentration of about 0.6 M. In some embodiments, the lithium salt is present at a concentration of about 0.7 M. In some other embodiments, the lithium salt is present at a concentration of about 0.8 M. In other embodiments, the lithium salt is present at a concentration of about 0.9 M. In still other embodiments, the lithium salt is present at a concentration of about 1.0 M. In certain embodiments, the lithium salt is present at a concentration of about 1.1 M. In certain embodiments, the lithium salt is present at a concentration of about 1.2 M. In certain embodiments, the lithium salt is present at a concentration of about 1.3 M. In certain embodiments, the lithium salt is present at a concentration of about 1.4 M. In certain embodiments, the lithium salt is present at a concentration of about 1.5 M. In certain embodiments, the lithium salt is present at a concentration of about 1.6 M. In certain embodiments, the lithium salt is present at a concentration of about 1.7 M. In certain embodiments, the lithium salt is present at a concentration of about 1.8 M. In certain embodiments, the lithium salt is present at a concentration of about 1.9 M. In certain embodiments, the lithium salt is present at a concentration of about 2.0 M. In certain embodiments, the lithium salt is present at a concentration of about 2.1 M. In certain embodiments, the lithium salt is present at a concentration of about 2.2 M. In certain embodiments, the lithium salt is present at a concentration of about 2.3 M. In certain embodiments, the lithium salt is present at a concentration of about 2.4 M. In certain embodiments, the lithium salt is present at a concentration of about 2.5 M. In certain embodiments, the lithium salt is present at a concentration of about 2.6 M. In certain embodiments, the lithium salt is present at a concentration of about 2.7 M. In certain embodiments, the lithium salt is present at a concentration of about 2.8 M. In certain embodiments, the lithium salt is present at a concentration of about 2.9 M. In certain embodiments, the lithium salt is present at a concentration of about 3.0 M. In certain embodiments, the lithium salt is present at a concentration of about 3.1 M. In certain embodiments, the lithium salt is present at a concentration of about 3.2 M. In certain embodiments, the lithium salt is present at a concentration of about 3.3 M. In certain embodiments, the lithium salt is present at a concentration of about 3.4 M. In certain embodiments, the lithium salt is present at a concentration of about 3.5 M. In certain embodiments, the lithium salt is present at a concentration of about 3.6 M. In certain embodiments, the lithium salt is present at a concentration of about 3.7 M. In certain embodiments, the lithium salt is present at a concentration of about 3.8 M. In certain embodiments, the lithium salt is present at a concentration of about 3.9 M. In certain embodiments, the lithium salt is present at a concentration of about 4.0 M. In certain embodiments, the lithium salt is present at a concentration of about 4.1 M. In certain embodiments, the lithium salt is present at a concentration of about 4.2 M. In certain embodiments, the lithium salt is present at a concentration of about 4.3 M. In certain embodiments, the lithium salt is present at a concentration of about 4.4 M. In certain embodiments, the lithium salt is present at a concentration of about 4.5 M. In certain embodiments, the lithium salt is present at a concentration of about 4.6 M. In certain embodiments, the lithium salt is present at a concentration of about 4.7 M. In certain embodiments, the lithium salt is present at a concentration of about 4.8 M. In certain embodiments, the lithium salt is present at a concentration of about 4.9 M. In certain embodiments, the lithium salt is present at a concentration of about 5.0 M.

In some embodiments, including any of the foregoing, the lithium salt is present at a concentration of 0.5 M to 2.5 M. In some other embodiments, including any of the foregoing, the lithium salt is present at a concentration of 0.5 M to 2.0 M. In certain embodiments, the lithium salt is present at a concentration of 0.5 M. In certain other embodiments, the lithium salt is present at a concentration of 0.6 M. In some embodiments, the lithium salt is present at a concentration of 0.7 M. In some other embodiments, the lithium salt is present at a concentration of 0.8 M. In other embodiments, the lithium salt is present at a concentration of 0.9 M. In still other embodiments, the lithium salt is present at a concentration of 1.0 M. In certain embodiments, the lithium salt is present at a concentration of 1.1 M. In certain embodiments, the lithium salt is present at a concentration of 1.2 M. In certain embodiments, the lithium salt is present at a concentration of 1.3 M. In certain embodiments, the lithium salt is present at a concentration of 1.4 M. In certain embodiments, the lithium salt is present at a concentration of 1.5 M. In certain embodiments, the lithium salt is present at a concentration of 1.6 M. In certain embodiments, the lithium salt is present at a concentration of 1.7 M. In certain embodiments, the lithium salt is present at a concentration of 1.8 M. In certain embodiments, the lithium salt is present at a concentration of 1.9 M. In certain embodiments, the lithium salt is present at a concentration of 2.0 M. In certain embodiments, the lithium salt is present at a concentration of 2.1 M. In certain embodiments, the lithium salt is present at a concentration of 2.2 M. In certain embodiments, the lithium salt is present at a concentration of 2.3 M. In certain embodiments, the lithium salt is present at a concentration of 2.4 M. In certain embodiments, the lithium salt is present at a concentration of 2.5 M. In certain embodiments, the lithium salt is present at a concentration of 2.6 M. In certain embodiments, the lithium salt is present at a concentration of 2.7 M. In certain embodiments, the lithium salt is present at a concentration of 2.8 M. In certain embodiments, the lithium salt is present at a concentration of 2.9 M. In certain embodiments, the lithium salt is present at a concentration of 3.0 M. In certain embodiments, the lithium salt is present at a concentration of 3.1 M. In certain embodiments, the lithium salt is present at a concentration of 3.2 M. In certain embodiments, the lithium salt is present at a concentration of 3.3 M. In certain embodiments, the lithium salt is present at a concentration of 3.4 M. In certain embodiments, the lithium salt is present at a concentration of 3.5 M. In certain embodiments, the lithium salt is present at a concentration of 3.6 M. In certain embodiments, the lithium salt is present at a concentration of 3.7 M. In certain embodiments, the lithium salt is present at a concentration of 3.8 M. In certain embodiments, the lithium salt is present at a concentration of 3.9 M. In certain embodiments, the lithium salt is present at a concentration of 4.0 M. In certain embodiments, the lithium salt is present at a concentration of 4.1 M. In certain embodiments, the lithium salt is present at a concentration of 4.2 M. In certain embodiments, the lithium salt is present at a concentration of 4.3 M. In certain embodiments, the lithium salt is present at a concentration of 4.4 M. In certain embodiments, the lithium salt is present at a concentration of 4.5 M. In certain embodiments, the lithium salt is present at a concentration of 4.6 M. In certain embodiments, the lithium salt is present at a concentration of 4.7 M. In certain embodiments, the lithium salt is present at a concentration of 4.8 M. In certain embodiments, the lithium salt is present at a concentration of 4.9 M. In certain embodiments, the lithium salt is present at a concentration of 5.0 M.

In some embodiments, including any of the foregoing, at least one C₃₋₁₀ heterocyclic molecules is sulfolane.

In some embodiments, including any of the foregoing, at least one C₃₋₁₀ heterocyclic molecules is 1,3-propane sultone.

In some embodiments, including any of the foregoing, at least one C₃₋₁₀ heterocyclic molecules is sulfolene.

In some embodiments, including any of the foregoing, at least one C₃₋₁₀ heterocyclic molecules is thiophene.

In some embodiments, including any of the foregoing, at least one C₃₋₁₀ heterocyclic molecules is ethylene sulfite.

In some embodiments, including any of the foregoing, the catholyte includes ethylene sulfite and sulfolane.

In some embodiments, including any of the foregoing, the catholyte consists essentially of ethylene sulfite and sulfolane.

In some embodiments, including any of the foregoing, the catholyte consists essentially of ethylene sulfite and sulfolane in a 70:30 volume ratio.

In some embodiments, including any of the foregoing, the catholyte consists of ethylene sulfite and sulfolane.

In some embodiments, including any of the foregoing, the catholyte consists of ethylene sulfite and sulfolane in a 70:30 volume ratio.

In some embodiments, including any of the foregoing, the catholyte includes two C₃₋₁₀ heterocyclic molecules, wherein a ratio of one C₃₋₁₀ heterocyclic molecule to the other [symbol] C₃₋₁₀ heterocyclic molecules is from 20:80 vol/vol (v/v) to 80:20 v/v.

In some embodiments, including any of the foregoing, the ratio of one C₃₋₁₀ heterocyclic molecule to the other C₃₋₁₀ heterocyclic molecules is from 15:85 vol/vol (v/v) to 85:15 v/v.

In some embodiments, including any of the foregoing, the ratio of one C₃₋₁₀ heterocyclic molecule to the other C₃₋₁₀ heterocyclic molecules is from 20:80 vol/vol (v/v) to 80:20 v/v.

In some embodiments, including any of the foregoing, the ratio of one C₃₋₁₀ heterocyclic molecule to the other C₃₋₁₀ heterocyclic molecules is from 25:75 vol/vol (v/v) to 75:25 v/v.

In some embodiments, including any of the foregoing, the ratio of one C₃₋₁₀ heterocyclic molecule to the other C₃₋₁₀ heterocyclic molecules is from 30:70 vol/vol (v/v) to 70:30 v/v.

In some embodiments, including any of the foregoing, the ratio of one C₃₋₁₀ heterocyclic molecule to the other C₃₋₁₀ heterocyclic molecules is from 35:65 vol/vol (v/v) to 65:35 v/v.

In some embodiments, including any of the foregoing, the ratio of one C₃₋₁₀ heterocyclic molecule to the other C₃₋₁₀ heterocyclic molecules is from 40:60 vol/vol (v/v) to 60:40 v/v.

In some embodiments, including any of the foregoing, the ratio of one C₃₋₁₀ heterocyclic molecule to the other C₃₋₁₀ heterocyclic molecules is from 45:55 vol/vol (v/v) to 55:45 v/v.

In some embodiments, including any of the foregoing, the ratio of one C₃₋₁₀ heterocyclic molecule to the other C₃₋₁₀ heterocyclic molecules is 50:50 vol/vol (v/v).

In some embodiments, including any of the foregoing, the ratio of sulfolane:(ethylene sulfite) is from 30:70 v/v to 50:50 v/v.

In some embodiments, including any of the foregoing, the ratio of sulfolane:(ethylene sulfite) is 30:70 v/v.

In some embodiments, including any of the foregoing, the ratio of sulfolane:(ethylene sulfite) is 50:50 v/v.

In some embodiments, including any of the foregoing, the catholyte also includes an additive selected from the group consisting of tris(trimethysilyl) phosphite (TTSPi), tris(trimethysilyl) phosphate (TTSPa), trimethoxyboroxine (C₃H₉B₃O₆, TMOBX), vinylene carbonate (VC), vinyl ethylene carbonate (VEC), methylene methane disulfonate (MMDS), prop-1-ene-1,3 sultone (PES), fluoroethylene carbonate (FEC), LiTFSi, LiBOB, succinonitrile, trimethylene sulfate (TMS), triallyl phosphate (TAP), tris(trimethylsilyl) borate (TMSB), tris(pentafluorophenyl) borane (TPFPB), and combinations thereof.

In some embodiments, including any of the foregoing, the additive is TTSPi.

In some embodiments, including any of the foregoing, the additive is TTSPa.

In some embodiments, including any of the foregoing, the additive is a combination of TTSPi and TTSPa.

In some embodiments, including any of the foregoing, the lithium-stuffed garnet is characterized by a formula selected from the group consisting of Li_{A}La_{B}M′_{C}M″_{D}Zr_{E}O_{F}, Li_{A}La_{B}M′_{C}M″_{D}Ta_{E}O_{F}, and Li_{A}La_{B}M′_{C}M″_{D}Nb_{E}O_{F}, wherein 4<A<8.5, 1.5<B<4, 0≤C<2, 0≤D<2; 0<E<2, 10<F<14, and wherein M′ and M″ are each, independently, selected from the group consisting of Al, Mo, W, Nb, Ga, Y, Gd, Sb, Ca, Ba, Sr, Ce, Hf, Rb, and Ta.

In some embodiments, including any of the foregoing, the lithium-stuffed garnet characterized by a formula selected from the group consisting of Li_{A}La_{B}M′_{C}M″_{D}Zr_{E}O_{F}, Li_{A}La_{B}M′_{C}M″_{D}Ta_{E}O_{F}, and Li_{A}La_{B}M′_{C}M″_{D}Nb_{E}O_{F}, wherein 4<A<8.5, 1.5<B<4, 0≤C<2.5, 0≤D<2.5; 0<E<2.5, 10<F<14, and wherein M′ and M″ are each, independently, selected from the group consisting of Al, Mo, W, Nb, Ga, Y, Gd, Sb, Ca, Ba, Sr, Ce, Hf, Rb, and Ta

In some embodiments, including any of the foregoing, the lithium-stuffed garnet is characterized by a formula selected from the group consisting of LiₐLa_{b}Zr_{c}Al_{d}Me″ₑO_{f} wherein 5<a<7.7; 2<b<4; 0<c<2.5; 0<d<2.5; 0≤e<2.5, 10<f<14, and wherein Me″ is a metal selected from the group consisting of Nb, Ta, V, W, Mo, and Sb.

In some embodiments, including any of the foregoing, the lithium-stuffed garnet is characterized by a formula selected from the group consisting of LiₐLa_{b}Zr_{c}Al_{d}O_{f} wherein 5<a<7.7; 2<b<4; 0<c<2.5; 0<d<2.5; 10<f<14.

In some embodiments, including any of the foregoing, set forth herein is an electrochemical cell that includes a catholyte described herein.

In some embodiments, including any of the foregoing, set forth herein is a rechargeable battery including an electrochemical cell set forth herein.

In some embodiments, including any of the foregoing, set forth herein is an electric vehicle comprising a rechargeable battery set forth herein.

In certain embodiments, including any of the foregoing, the substitutes are selected from polyethylene glycol (PEG), ═O, SO₂, —CF₃, —CH₂F, CHF₂, —NO₂, —NO₃, —NH₃, —CH₃, PO₄, PO₃, BO₃ and —CN.

### Methods of Making

In another example, provided herein is a method for making an electrochemical cell, including: providing catholyte in a positive electrode, the catholyte comprising a lithium salt; and at least two C₃₋₁₀ heterocyclic molecules, each independently, in each instance, comprising at least one sulfur (S) ring atom and optionally substituted with 1 to 6 substituents; and contacting a solid-state electrolyte including lithium-stuffed garnet to the positive electrode.

In another example, provided herein is a method for making catholyte solution, comprising: mixing at least two C₃₋₁₀ heterocyclic molecules, each independently, in each instance, comprising at least one sulfur (S) ring atom and optionally substituted with 1 to 6 substituents; and a lithium salt; thereby providing a catholyte solution.

In some embodiments, including any of the foregoing, the methods further include contacting a solid-state electrolyte comprising lithium-stuffed garnet with the catholyte solution

In some embodiments, including any of the foregoing, set forth herein is an electrochemical cell made by a method described herein.

In some embodiments, including any of the foregoing, set forth herein is a rechargeable battery including an electrochemical cell set forth herein.

In some embodiments, including any of the foregoing, set forth herein is an electric vehicle comprising a rechargeable battery set forth herein.

In some embodiments, including any of the foregoing, set forth herein is a method of making a catholyte. In some embodiments, a mixture of 50:50 ethylene sulfite:sulfolane to 70:30 ES:S by volume is prepared. In some embodiments, a mixture of 40:60 ethylene sulfite:sulfolane by volume is prepared. In some embodiments, a mixture of 60:40 ethylene sulfite:sulfolane ES:S by volume is prepared. In some embodiments, a mixture of 80:20 ethylene sulfite:sulfolane by volume is prepared. In some embodiments, a mixture of 20:80 ethylene sulfite:sulfolane by volume is prepared.

In some embodiments, including any of the foregoing, propylene glycol sulfite is used instead of ethylene sulfite.

In some embodiments, including any of the foregoing, other additives are used, e.g., TTSPi (Tris trimethylsilyl phosphite).

After drying, a lithium salt is added at salt concentrations from 0.8 M-2M.

In some embodiments, including any of the foregoing, the salt is selected from the group consisting of LiPF₆, Lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiI, and combinations thereof.

In some embodiments, including any of the foregoing, the salt is LiPF₆ or LiBF₄.

In some embodiments, including any of the foregoing, the salt is LiPF₆.

In some embodiments, including any of the foregoing, the salt is LiBF₄.

In some embodiments, including any of the foregoing, other anion mixtures are used, such as but not limited to, LiFSi, LiTFSi, e.g., 1.4M Li+ with 80:20 LiBF₄ to LiFSi.

In some embodiments, including any of the foregoing, 1,2-propyleneglycol sulfite (CAS 1469-73-4) is used as an additive with ESS.

In some embodiments, including any of the foregoing, 1,3,2-dioxathiolane 2,2-dioxide (CAS 1072-53-3) is used as an additive with ESS.

In some embodiments, including any of the foregoing, the C₃₋₁₀ heterocyclic molecule comprises at least one sulfur (S) ring atom.

In some embodiments, including any of the foregoing, the C₃₋₁₀ heterocyclic molecule comprises at least one sulfur (S) ring atom and one oxygen (O) ring atom.

In certain embodiments, set forth herein is a catholyte solution comprising: a lithium salt; and at least two aprotic C₃₋₁₀ heterocyclic molecules, each independently, in each instance, comprising at least one sulfur (S) ring atom and optionally substituted with 1 to 6 substituents; wherein at least one C₃₋₁₀ heterocyclic molecule is selected from the group consisting of ethylene sulfite; 4-methyl-1,3,2-dioxathiolane 2-oxide; 1,3-propane sultone; sulfolane; thiophene; thiazole; 1,2-oxathiolane; thiepine; 1,4-thiazepine; 6-H-1,2,5-thiadiazine; 2H,6H-1,5,2-dithiazine; methylene methanedisulfonate; ethylene sulfate; thiopyran; thiocine, derivatives thereof, and combinations thereof.

In some embodiments, including any of the foregoing, the at least one aprotic C₃₋₁₀ heterocyclic molecule is selected from the group consisting of ethylene sulfite and propylene glycol sulfite.

In some embodiments, including any of the foregoing, the catholyte solution is in contact with a solid-state electrolyte comprising lithium-stuffed garnet, wherein the solid-state electrolyte is a thin film.

In some embodiments, including any of the foregoing, the solid-state electrolyte comprising lithium-stuffed garnet is a sintered thin film.

In some embodiments, including any of the foregoing, the lithium salt is selected from the group consisting of LiPF₆, Lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiI, and combinations thereof.

In some embodiments, including any of the foregoing, the lithium salt is present at a concentration of about 0.5 M to about 2.0 M.

In some embodiments, including any of the foregoing, the at least one C₃₋₁₀ heterocyclic molecules is sulfolane.

In some embodiments, including any of the foregoing, the at least one C₃₋₁₀ heterocyclic molecules is 1,3-propane sultone.

In some embodiments, including any of the foregoing, the at least one C₃₋₁₀ heterocyclic molecules is sulfolene.

In some embodiments, including any of the foregoing, the at least one C₃₋₁₀ heterocyclic molecules is thiophene.

In some embodiments, including any of the foregoing, the at least one C₃₋₁₀ heterocyclic molecules is ethylene sulfite.

In some embodiments, including any of the foregoing, the catholyte solution includes two C₃₋₁₀ heterocyclic molecules, wherein a ratio of one C₃₋₁₀ heterocyclic molecule to the other C₃₋₁₀ heterocyclic molecules is from 10:90 vol/vol (v/v) to 90:10 v/v.

In some embodiments, including any of the foregoing, the catholyte solution includes two C₃₋₁₀ heterocyclic molecules, wherein a ratio of one C₃₋₁₀ heterocyclic molecule to the other C₃₋₁₀ heterocyclic molecules is from 20:80 vol/vol (v/v) to 80:20 v/v.

In some embodiments, including any of the foregoing, the catholyte solution includes sulfolane and ethylene sulfite, and wherein the ratio of sulfolane:(ethylene sulfite) is from 30:70 v/v to 50:50 v/v.

In some embodiments, including any of the foregoing, the catholyte solution includes sulfolane and ethylene sulfite, and wherein the ratio of sulfolane:(ethylene sulfite) is 30:70 v/v.

In some embodiments, including any of the foregoing, the catholyte solution includes sulfolane and ethylene sulfite, and wherein the ratio of sulfolane:(ethylene sulfite) is 50:50 v/v.

In some embodiments, including any of the foregoing, the catholyte solution includes a Lewis acid selected from the group consisting of tris(trimethysilyl) phosphite (TTSPi); tris(trimethysilyl) phosphate (TTSPa); trimethoxyboroxine (C₃H₉B₃O₆, TMOBX); vinylene carbonate (VC); vinyl ethylene carbonate (VEC); methylene methane disulfonate (MMDS); prop-1-ene-1,3 sultone (PES); 1,3-propane sultone; fluoroethylene carbonate (FEC); LiTFSi; LiBOB; succinonitrile, trimethylene sulfate (TMS); triallyl phosphate (TAP); tris(trimethylsilyl) borate (TMSB); tris(pentafluorophenyl) borane (TPFPB); tris(pentafluorophenyl)borane (TPFPB); methyl acetate (MA); tris(trimethylsilyl) acetate (TMSA); tris(trimethylsilyl) pyridine; tris(trimethylsilyl) methacrylate (TMSMA); tris (2,2,2-trifluoroethyl) phosphite (TTFEP); tris(2,2,2-trifluoroethyl) borate (TTFEB); and combinations thereof.

In some embodiments, including any of the foregoing, the additive is TTSPi.

In some embodiments, including any of the foregoing, the additive is TTSPa.

In some embodiments, including any of the foregoing, the additive is a combination of TTSPi and TTSPa.

In some embodiments, including any of the foregoing, the solid-state electrolyte is a lithium-stuffed garnet characterized by a formula selected from the group consisting of Li_{A}La_{B}M′_{C}M″_{D}Zr_{E}O_{F}, Li_{A}La_{B}M′_{C}M″_{D}Ta_{E}O_{F}, and Li_{A}La_{B}M′_{C}M″_{D}Nb_{E}O_{F}, wherein 4<A<8.5, 1.5<B<4, 0≤C<2.5, 0≤D<2.5; 0<E<2.5, 10<F<14, and wherein M′ and M″ are each, independently, selected from the group consisting of Al, Mo, W, Nb, Ga, Y, Gd, Sb, Ca, Ba, Sr, Ce, Hf, Rb, and Ta.

In some embodiments, including any of the foregoing, the catholyte solution has a boiling point within a range from 60° C. to 100° C.

In some embodiments, including any of the foregoing, the catholyte solution has a melting point within a range from −60° C. to −40° C.

In some embodiments, including any of the foregoing, the catholyte solution has a lithium-ion conductivity within a range of 2000 μS/cm to 3200 μS/cm.

In some embodiments, including any of the foregoing, the catholyte solution has a viscosity within a range of 1 centipoise (cP) to 10 cP.

In some embodiments, including any of the foregoing, the lithium salt is 1.4M LiPF₆; 1.4M LiBF₄; or 1.6M LiBF₄.

In some embodiments, including any of the foregoing, the catholyte solution includes 70:30 v/v % ethylene sulfite:sulfolane.

### Additional Embodiments

In some embodiments, set forth herein is a catholyte solution including: a lithium salt; and at least two aprotic C₃₋₁₀ heterocyclic molecules, each independently, in each instance, comprising at least one sulfur (S) ring atom and optionally substituted with 1 to 6 substituents.

In some embodiments, set forth herein is a catholyte solution including: a lithium salt; an aprotic C₃₋₁₀ heterocyclic molecule comprising at least one sulfur (S) ring atom and optionally substituted with 1 to 6 substituents.

In some embodiments, including any of the foregoing, the catholyte includes an organic carbonate solvent.

In some embodiments, including any of the foregoing, the catholyte includes ethylene carbonate.

In some embodiments, including any of the foregoing, the catholyte includes diethyl carbonate, dimethyl carbonate, or a combination thereof.

In some embodiments, including any of the foregoing, the catholyte includes methyl acetate.

In some embodiments, including any of the foregoing, the catholyte includes at least one aprotic C₃₋₁₀ heterocyclic molecule is selected from the group consisting of ethylene sulfite; 4-methyl-1,3,2-dioxathiolane 2-oxide; 1,3-propane sultone; sulfolane; thiophene, thiazole, 1,2-oxathiolane, thiepine, 1,4-thiazepine, 6-H-1,2,5-thiadiazine, 2H,6H-1,5,2-dithiazine; methylene methanedisulfonate; ethylene sulfate; thiopyran, thiepine, thiocine, derivatives thereof, and combinations thereof.

In some embodiments, including any of the foregoing, the catholyte includes at least one aprotic C₃₋₁₀ heterocyclic molecule is selected from the group consisting of ethylene sulfite and propylene glycol sulfite.

In some embodiments, including any of the foregoing, the catholyte includes at least one aprotic C₃₋₁₀ heterocyclic molecule is selected from the group consisting of ethylene sulfite and sulfolane.

In some embodiments, including any of the foregoing, the catholyte is in contact with a solid-state electrolyte comprising lithium-stuffed garnet, wherein the solid-state electrolyte is a thin film.

In some embodiments, including any of the foregoing, the solid-state electrolyte comprising lithium-stuffed garnet is a sintered thin film.

In some embodiments, including any of the foregoing, the lithium salt is selected from the group consisting of LiPF₆, lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiI, LiBr, LiCl, and combinations thereof.

In some embodiments, including any of the foregoing, the lithium salt is present at a concentration of about 0.5 M to about 5.0 M.

In some embodiments, including any of the foregoing, the lithium salt is LiPF₆; LiBF₄; or LiBF₄.

In some embodiments, including any of the foregoing, the lithium salt is 1.4M LiPF₆; 1.4M LiBF₄; or 1.6M LiBF₄.

In some embodiments, including any of the foregoing, the lithium salt is LiBF₄.

In some embodiments, including any of the foregoing, the lithium salt is 1.4M LiBF₄ or 1.6M LiBF₄.

In some embodiments, including any of the foregoing, the catholyte includes 70:30 v/v % ethylene sulfite:sulfolane.

In some embodiments, including any of the foregoing, the at least one aprotic C₃₋₁₀ heterocyclic molecules is sulfolane.

In some embodiments, including any of the foregoing, the at least one aprotic C₃₋₁₀ heterocyclic molecules is 1,3-propane sultone.

In some embodiments, including any of the foregoing, the at least one aprotic C₃₋₁₀ heterocyclic molecules is sulfolene.

In some embodiments, including any of the foregoing, the at least one aprotic C₃₋₁₀ heterocyclic molecules is thiophene.

In some embodiments, including any of the foregoing, the at least one aprotic C₃₋₁₀ heterocyclic molecules is ethylene sulfite.

In some embodiments, including any of the foregoing, the catholyte includes ethylene sulfite and sulfolane.

In some embodiments, including any of the foregoing, the catholyte consists essentially of ethylene sulfite and sulfolane.

In some embodiments, including any of the foregoing, the catholyte includes two C₃₋₁₀ heterocyclic molecules, wherein a ratio of one C₃₋₁₀ heterocyclic molecule to the other C₃₋₁₀ heterocyclic molecules is from 10:90 vol/vol (v/v) to 90:10 v/v.

In some embodiments, including any of the foregoing, the catholyte includes two C₃₋₁₀ heterocyclic molecules, wherein a ratio of one C₃₋₁₀ heterocyclic molecule to the other C₃₋₁₀ heterocyclic molecules is from 20:80 vol/vol (v/v) to 80:20 v/v.

In some embodiments, including any of the foregoing, the catholyte includes ratio is 30:70 vol/vol (v/v).

In some embodiments, including any of the foregoing, the catholyte includes sulfolane:ethylene sulfite at 30:70 v/v.

In some embodiments, including any of the foregoing, the catholyte includes sulfolane and ethylene sulfite, and wherein the ratio of sulfolane:(ethylene sulfite) is from 30:70 v/v to 50:50 v/v.

In some embodiments, including any of the foregoing, the catholyte includes sulfolane and ethylene sulfite, and wherein the ratio of sulfolane:(ethylene sulfite) is 30:70 v/v.

In some embodiments, including any of the foregoing, the catholyte includes sulfolane and ethylene sulfite, and wherein the ratio of sulfolane:(ethylene sulfite) is 50:50 v/v.

In some embodiments, including any of the foregoing, the catholyte includes sulfolane and ethylene sulfite, wherein the concentration of lithium salt is 0.5 molar (M) to 5 M.

In some embodiments, including any of the foregoing, the catholyte includes sulfolane and ethylene sulfite, wherein the concentration of LiBF₄ is 0.5 molar (M) to 5 M.

In some embodiments, including any of the foregoing, the catholyte includes an additive selected from the group consisting of tris(trimethysilyl) phosphite (TTSPi); tris(trimethysilyl) phosphate (TTSPa); trimethoxyboroxine (C3H9B306, TMOBX); vinylene carbonate (VC); vinyl ethylene carbonate (VEC); methylene methane disulfonate (MMDS); prop-1-ene-1,3 sultone (PES); 1,3-propane sultone; fluoroethylene carbonate (FEC); LiTFSi; LiBOB; succinonitrile; trimethylene sulfate (TMS); triallyl phosphate (TAP); tris(trimethylsilyl) borate (TMSB); tris(pentafluorophenyl) borane (TPFPB); tris(trimethylsilyl) borate (TMSB); tris(pentafluorophenyl)borane (TPFPB); methyl acetate (MA); tris(trimethylsilyl) acetate (TMSA); tris(trimethylsilyl) pyridine; tris(trimethylsilyl) methacrylate (TMSMA); tris (2,2,2-trifluoroethyl) phosphite (TTFEP); tris(2,2,2-trifluoroethyl) borate (TTFEB) and combinations thereof.

In some embodiments, including any of the foregoing, the additive is TTSPi.

In some embodiments, including any of the foregoing, the additive is TTSPa.

In some embodiments, including any of the foregoing, the additive is a combination of TTSPi and TTSPa.

In some embodiments, including any of the foregoing, the solid-state electrolyte is a lithium-stuffed garnet characterized by a formula selected from the group consisting of Li_{A}La_{B}M′_{C}M″_{D}Zr_{E}O_{F}, Li_{A}La_{B}M′_{C}M″_{D}Ta_{E}O_{F}, and Li_{A}La_{B}M′_{C}M″_{D}Nb_{E}O_{F}, wherein 4<A<8.5, 1.5<B<4, 0≤C<2.5, 0≤D<2.5; 0<E<2.5, 10<F<14, and wherein M′ and M″ are each, independently, selected from the group consisting of Al, Mo, W, Nb, Ga, Y, Gd, Sb, Ca, Ba, Sr, Ce, Hf, Rb, and Ta.

In some embodiments, including any of the foregoing, the lithium-stuffed garnet is characterized by a formula selected from the group consisting of LiₐLa_{b}Zr_{c}Al_{d}Me″ₑO_{f} wherein 5<a<7.7; 2<b<4; 0<c<2.5; 0<d<2.5; 0≤e<2.5, 10<f<14, and wherein Me″ is a metal selected from the group consisting of Nb, Ta, V, W, Mo, and Sb.

In some embodiments, including any of the foregoing, the lithium-stuffed garnet is characterized by a formula selected from the group consisting of LiₐLa_{b}Zr_{c}Al_{d}O_{f} wherein 5<a<7.7; 2<b<4; 0<c<2.5; 0<d<2.5; 10<f<14.

In some embodiments, including any of the foregoing, the catholyte solution is disposed in an electrochemical cell which comprises a positive electrode, a lithium-metal negative electrode, and a solid-state electrolyte comprising lithium-stuffed garnet.

In some embodiments, including any of the foregoing, the catholyte includes a third component that is not an aprotic C₃₋₁₀ heterocyclic molecules comprising at least one sulfur (S) ring atom and optionally substituted with 1 to 6 substituents.

In some embodiments, including any of the foregoing, the third component is selected from the group consisting of gamma butyrolactone, gamma valerolactone, gamma octalactone, ethyl cyanoacetate, trimethyl phosphate, adiponitrile, glutaronitrile, malononitrile, methyl acetate, ethyl cyanoacrylate, malononitrile, methyl cyanoacetate, ethyl cyanoacrylate, methyl cyanoacrylate, methoxyacetonitrile, acetonitrile, succinonitrile, malononitrile, methyl cyanoacetate, ethyl cyanoacrylate, methyl cyanoacrylate, and combinations thereof.

In some embodiments, including any of the foregoing, the third component is methyl acetate.

In some embodiments, set forth herein is a method for making catholyte solution, comprising: mixing at least two C₃₋₁₀ heterocyclic molecules, each independently, in each instance, comprising at least one sulfur (S) ring atom and optionally substituted with 1 to 6 substituents; and a lithium salt; thereby providing a catholyte solution.

In some embodiments, including any of the foregoing, the methods include contacting a solid-state electrolyte comprising lithium-stuffed garnet with the catholyte solution.

In some embodiments, set forth herein is a method for making an electrochemical cell, comprising: providing catholyte in a positive electrode, the catholyte comprising: a lithium salt; and at least two C₃₋₁₀ heterocyclic molecules, each independently, in each instance, comprising at least one sulfur (S) ring atom and optionally substituted with 1 to 6 substituents; and contacting a solid-state electrolyte comprising lithium-stuffed garnet to the positive electrode.

In some embodiments, set forth herein is an electrochemical cell made by a method disclosed herein.

In some embodiments, set forth herein is a rechargeable battery comprising an electrochemical cell disclosed herein.

In some embodiments, set forth herein is an electric vehicle comprising a rechargeable battery disclosed here.

In some embodiments, set forth herein is a catholyte solution including: a lithium salt; and at least two aprotic C₃₋₁₀ heterocyclic molecules, each independently, in each instance, comprising at least one sulfur (S) ring atom and optionally substituted with 1 to 6 substituents; wherein at least one C₃₋₁₀ heterocyclic molecule is selected from the group consisting of ethylene sulfite; 4-methyl-1,3,2-dioxathiolane 2-oxide; 1,3-propane sultone; sulfolane; thiophene; thiazole; 1,2-oxathiolane; thiepine; 1,4-thiazepine; 6-H-1,2,5-thiadiazine; 2H,6H-1,5,2-dithiazine; methylene methanedisulfonate; ethylene sulfate; thiopyran; thiocine, derivatives thereof, and combinations thereof.

In some embodiments, including any of the foregoing, the at least one aprotic C₃₋₁₀ heterocyclic molecule is selected from the group consisting of ethylene sulfite and propylene glycol sulfite.

In some embodiments, including any of the foregoing, the catholyte solution is in contact with a solid-state electrolyte comprising lithium-stuffed garnet, wherein the solid-state electrolyte is a thin film.

In some embodiments, including any of the foregoing, the solid-state electrolyte comprising lithium-stuffed garnet is a sintered thin film.

In some embodiments, including any of the foregoing, the lithium salt is selected from the group consisting of LiPF₆, Lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiF, LiCl, LiBr, LiI, and combinations thereof.

In some embodiments, including any of the foregoing, the lithium salt is LiBF₄.

In some embodiments, including any of the foregoing, the lithium salt is present at a concentration of about 0.5 M to about 2.0 M.

In some embodiments, including any of the foregoing, the at least one C₃₋₁₀ heterocyclic molecules is sulfolane.

In some embodiments, including any of the foregoing, the at least one C₃₋₁₀ heterocyclic molecules is 1,3-propane sultone.

In some embodiments, including any of the foregoing, the at least one C₃₋₁₀ heterocyclic molecules is sulfolene.

In some embodiments, including any of the foregoing, the at least one C₃₋₁₀ heterocyclic molecules is thiophene.

In some embodiments, including any of the foregoing, the at least one C₃₋₁₀ heterocyclic molecules is ethylene sulfite.

In some embodiments, including any of the foregoing, the ratio of one C₃₋₁₀ heterocyclic molecule to the other C₃₋₁₀ heterocyclic molecules is from 10:90 vol/vol (v/v) to 90:10 v/v.

In some embodiments, including any of the foregoing, the ratio of one C₃₋₁₀ heterocyclic molecule to the other C₃₋₁₀ heterocyclic molecules is from 20:80 vol/vol (v/v) to 80:20 v/v.

In some embodiments, including any of the foregoing, the catholyte includes sulfolane and ethylene sulfite, and wherein the ratio of sulfolane:(ethylene sulfite) is from 30:70 v/v to 50:50 v/v.

In some embodiments, including any of the foregoing, the catholyte includes sulfolane and ethylene sulfite, and wherein the ratio of sulfolane:(ethylene sulfite) is 30:70 v/v.

In some embodiments, including any of the foregoing, the catholyte includes sulfolane and ethylene sulfite, and wherein the ratio of sulfolane:(ethylene sulfite) is 50:50 v/v.

In some embodiments, including any of the foregoing, the catholyte includes an additive selected from the group consisting of tris(trimethysilyl) phosphite (TTSPi); tris(trimethysilyl) phosphate (TTSPa); trimethoxyboroxine (C₃H₉B₃O₆, TMOBX); vinylene carbonate (VC); vinyl ethylene carbonate (VEC); methylene methane disulfonate (MMDS); prop-1-ene-1,3 sultone (PES); 1,3-propane sultone; fluoroethylene carbonate (FEC); LiTFSi; LiBOB; succinonitrile, trimethylene sulfate (TMS); triallyl phosphate (TAP); tris(trimethylsilyl) borate (TMSB); tris(pentafluorophenyl) borane (TPFPB); tris(pentafluorophenyl)borane (TPFPB); methyl acetate (MA); tris(trimethylsilyl) acetate (TMSA); tris(trimethylsilyl) pyridine; tris(trimethylsilyl) methacrylate (TMSMA); tris (2,2,2-trifluoroethyl) phosphite (TTFEP); tris(2,2,2-trifluoroethyl) borate (TTFEB); and combinations thereof.

In some embodiments, including any of the foregoing, the additive is TTSPi.

In some embodiments, including any of the foregoing, the additive is TTSPa.

In some embodiments, including any of the foregoing, the additive is a combination of TTSPi and TTSPa.

In some embodiments, including any of the foregoing, the solid-state electrolyte is a lithium-stuffed garnet characterized by a formula selected from the group consisting of Li_{A}La_{B}M′_{C}M″_{D}Zr_{E}O_{F}, Li_{A}La_{B}M′_{C}M″_{D}Ta_{E}O_{F}, and Li_{A}La_{B}M′_{C}M″_{D}Nb_{E}O_{F}, wherein 4<A<8.5, 1.5<B<4, 0≤C<2.5, 0≤D<2.5; 0<E<2.5, 10<F<14, and wherein M′ and M″ are each, independently, selected from the group consisting of Al, Mo, W, Nb, Ga, Y, Gd, Sb, Ca, Ba, Sr, Ce, Hf, Rb, and Ta.

In some embodiments, including any of the foregoing, the catholyte solution has a boiling point within a range from 60° C. to 100° C.

In some embodiments, including any of the foregoing, the catholyte solution has a melting point within a range from −60° C. to −40° C.

In some embodiments, including any of the foregoing, the catholyte solution has a lithium-ion conductivity within a range of 2000 μS/cm to 3200 μS/cm.

In some embodiments, including any of the foregoing, the catholyte solution has a viscosity within a range of 1 cP to 10 cP.

In some embodiments, including any of the foregoing, the lithium salt is 1.4M LiPF₆; 1.4M LiBF₄; or 1.6M LiBF₄.

In some embodiments, including any of the foregoing, the catholyte includes 70:30 v/v % ethylene sulfite:sulfolane.

In some embodiments, including any of the foregoing, the lithium salt is 1.4M LiPF₆.

In some embodiments, including any of the foregoing, the lithium salt is 1.4M LiBF₄.

In some embodiments, including any of the foregoing, the lithium salt is 1.6M LiBF₄.

### EXAMPLES

Instruments used for electrochemical measurements were Bio-Logic potentiostat, Arbin Instruments battery cyclers, and Maccor battery cyclers.

Reagents, chemicals, and materials were commercially purchased unless specified otherwise to the contrary.

Pouch cell containers were purchased from Showa Denko.

The Electrochemical potentiostat used was an Arbin potentiostat.

Electrical impedance spectroscopy (EIS) was performed with a Biologic VMP3, VSP, VSP-300, SP-150, or SP-200.

Mixing was performed using a Fischer Scientific vortex mixer, a Flaktek speed mixer, or a Primix filmix homogenizer.

Casting was performed on a TQC drawdown table. Calendering was performed on an IMC calender.

Light scattering was performed on a Horiba, model: Partica, Model Number: LA-950V2, which is a laser scattering particle size distribution analyzer.

The Lithium Nickel Cobalt Manganese Oxide (NMC) used in the Examples was LiNi_{0.8}Co_{0.1}Mn_{0.1}O₂ unless specified otherwise.

### Example 1: Low Temperature Power

A cathode electrode slurry was prepared by mixing 3% Super C65, 1% ketjen black, 5% Kynar HSV, and 91% by weight LiNi_{0.8}Co_{0.1}Mn_{0.1}O₂ (also known as NMC811) in N-methyl pyrrolidone (NMP). After mixing and degassing, the slurry was cast onto an aluminum foil with a doctor blade to a thickness that achieves 28 mg/cm² of dry material. The electrode was dried of NMP at 120° C. for eight hours. The electrode was calendered to a thickness where the porosity was 35% by volume as determined by scanning electron microscopy. Cathode electrode discs of 8 mm diameter were punched from the cathode electrode sheet.

Electrochemical cells were constructed using a lithium-stuffed garnet separator, lithium-free lithium metal anode, and the cathode electrode described above. Lithium-free means the cells were assembled in a discharged state. Before cell assembly, the cathode electrode was soaked in a catholyte mixture of ESS (70:30 v/v % ethylene sulfite:sulfolane+1.4M LiBF₄). Herein, “ESS” refers to a combination of ethylene sulfite and sulfolane. After soaking, excess electrolyte was removed by dabbing with a cloth, and then 0.5-3 μL of excess catholyte mixture was added to the cathode-separator interface with a pipette. An anode current collector foil with a tab was placed in contact with the anode side of the separator and a cathode current collector foil with a tab was placed in contact with the Al foil on the back of the cathode electrode. A pouch was sealed around the cell, with the tabs sticking out of the cell to make electrical connections to each electrode.

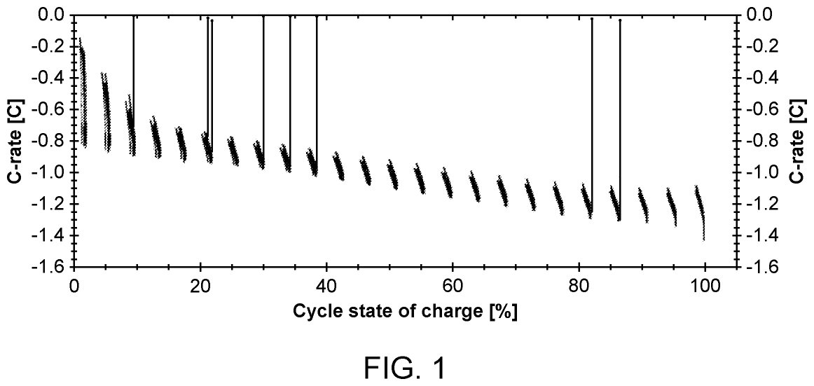

Electrochemical cells were charged and discharged at a rate of C/10, which is the current at which the battery is charged (or discharged) in 10 hours, from 3.4 V to 4.4 V at 25° C. FIG. 1 shows the results of a low temperature power test. A cell was charged to 4.4 V at 25° C. and then brought to −30° C. The cell was discharged for 30 seconds by applying a constant voltage of 2V and the current was monitored during the 30 seconds. After 30 seconds, there was a 10-minute rest at open circuit and then a C/10 discharge current was applied for 6 minutes. The 2V discharge, rest, and C/10 discharge was repeated until the cell voltage decreased below 2V during the C/10 discharge step. FIG. 1 shows the C-rate that was extracted during the 2V fast discharge step as a function of state of charge. The cell was able to deliver over 1C of current at −30° C. for 30 seconds while the state of charge is above about 60%, and over 0.5C of current for 30 seconds while the state of charge is above about 10%. 1C is the current at which the battery is discharged (or charged) in 1 hour. 0.5C is the current at which the battery is discharged (or charged) in 2 hours.

### Example 2: Fast Charging

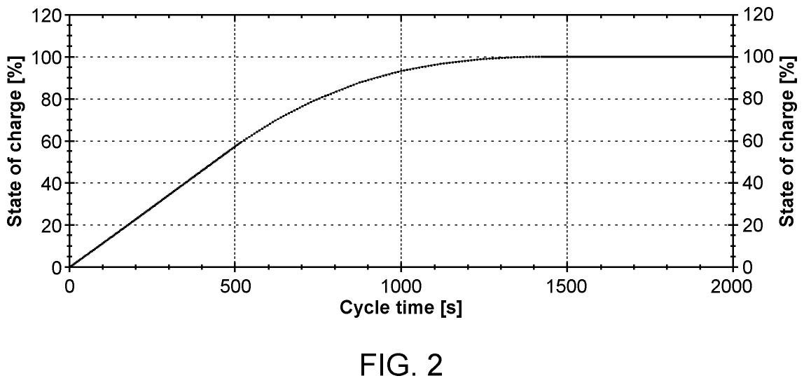

Electrochemical cells were constructed and formed as described in Example 1. A cell was heated to 25° C. and a 4C charging current was applied until the cell reached 4.4V, at which time a constant voltage of 4.4V was applied until the current fell below C/20 or 15 minutes, whichever came first. FIG. 2 shows the state of charge plotted against time, showing that the cell charged from 0-80% state of charge (SOC) in 12.5 minutes. In FIG. 2, the “ESS7.4” is synonymous with a 70:30 v/v mixture of ethylene sulfite and sulfolane with 1.4 M Li⁺ concentration. “ESS+1.6M LiBF₄” is a 70:30 v/v mixture of ethylene sulfite and sulfolane with 1.6 M Li⁺ concentration.

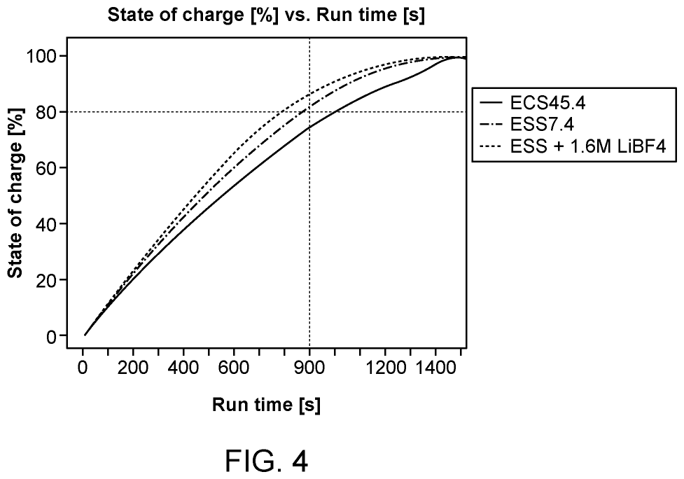

FIG. 4 shows a comparison of charging rate for cells with 3 different catholytes: a 45:55 mix of ethylene carbonate:sulfolane with 1.4M LiPF₆ (ECS), which is labeled ECS45.4, a 70:30 mix of ethylene sulfite:sulfolane with 1.6M LiBF₄ (ESS1), and a 70:30 mix of ethylene sulfite:sulfolane with 1.4M LiPF₆ (ESS2). Cells with ESS1 and ESS2 catholytes were able to charge from 0-80% state of charge in 12-15 minutes, whereas cells with ECS charged in 15-20 minutes.

Additional electrochemical cells were constructed and formed as described in Example 1. A cell was brought to 25° C. and a 4C charging current was applied until the cell reached 4.4V, at which time a constant voltage of 4.4V was applied until the current fell below C/20 or 15 minutes, whichever came first.

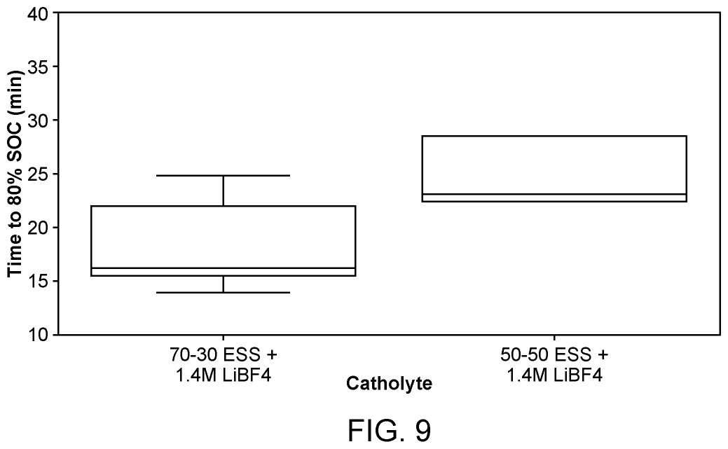

FIG. 9 shows a comparison of charging rate for cells with two catholytes: a 70:30 mixture by volume of ethylene sulfite:sulfolane with 1.4M LiBF₄, and a 50:50 mixture by volume of ethylene sulfite:sulfolane with 1.4M LiBF₄. Cells with a 70:30 mixture by volume of ethylene sulfite:sulfolane catholyte, with 1.4M LiBF₄, charged from 0-80% state of charge in 15-22 minutes, whereas cells with 50:50 mixture by volume of ethylene sulfite:sulfolane with 1.4M LiBF₄ charged in 23-30 minutes. The ratio of ethylene sulfite to sulfolane is shown in the label on the x-axis, e.g., the “70-30” in 70-30 ESS refers to a 70:30 volume ratio ethylene sulfite to sulfolane. The “50-50” in 50-50 ESS refers to a 50:50 volume ratio ethylene sulfite to sulfolane.

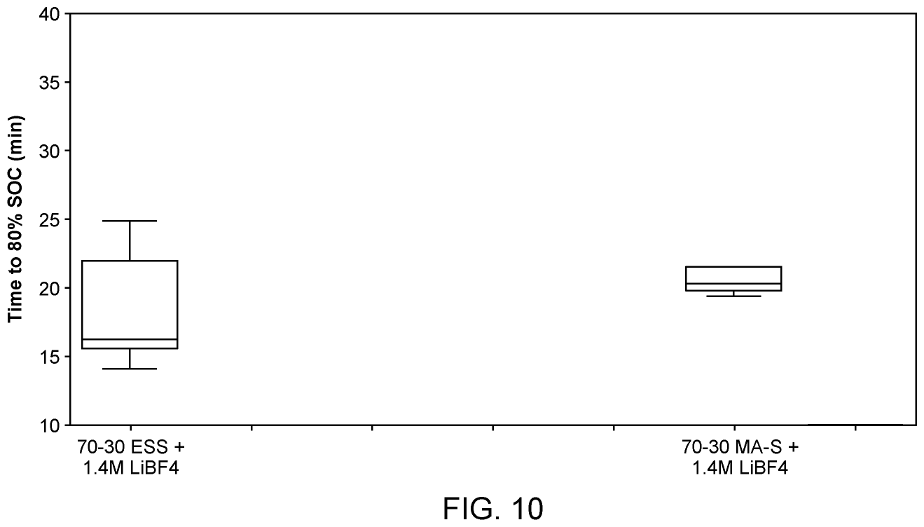

FIG. 10 shows a comparison of charging rate for cells with different catholytes as shown on the x-axis. These results are described in Example 2, herein. The ratio of ethylene sulfite to sulfolane is shown in the label on the x-axis, e.g., the “70-30” in 70-30 ESS refers to a 70:30 volume ratio ethylene sulfite to sulfolane. The “70-30” in 70-30 MA-S refers to a 70:30 volume ratio methyl acetate to sulfolane.

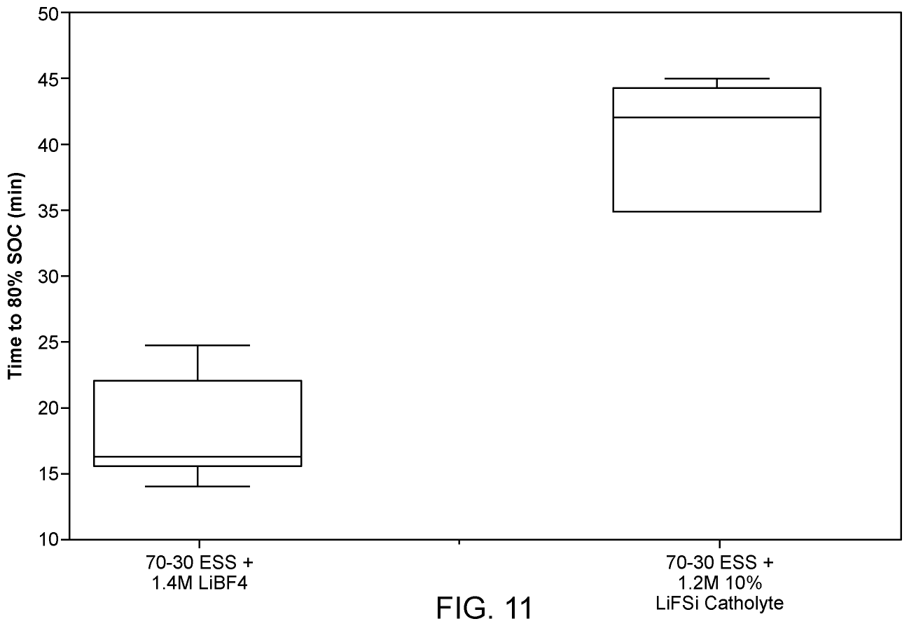

FIG. 11 shows a comparison of charging rate for cells with different catholytes as shown on the x-axis. In “70-30 ESS +1.2M 10% LiFSi,” the “1.2M” refers to the Li⁺ concentration in a solution of LiFSi. The “10%” means that the catholyte included 10% by volume of the LiFSi solution and 90% by volume of the 70-30 ESS 1.4 M LiBF₄ solution described above. “70-30 ESS+1.2M 10% LiFSi,” is a mixture that includes 90% by volume the 70-30 v/v solution of ethylene sulfite and sulfolane. “70-30 ESS+1.2M 10% LiFSi,” is a mixture that includes 10% by volume the 1.2M LiFSi solution.

### Example 3: Calendar Life

Cells were made and formed according to Example 1. The cells were then charged and discharged at a rate of C/3 between 3.4-4.4 V to measure an initial ASR (area--specific resistance) and then charged at C/3 to 4.4 V. C/3 is the current at which the battery is charged or discharged in 3 hours. The cells were held at open circuit voltage in a chamber at 60° C. for 7 days and then discharged at 25° C. at a rate of C/3 to 3.4V. The cells were then charged and discharged from 3.4-4.4 V at 25° C. at a rate of C/3 to measure a final ASR. The initial ASR and final ASR were used as metrics of calendar life of the cell. A cell preferably has a low initial ASR and little growth in ASR to a final ASR value.

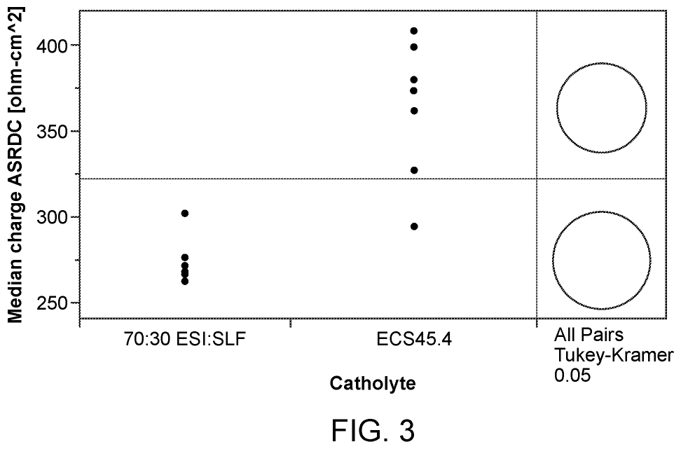

The area-specific resistance (ASR) in units of 22 cm² was calculated by determining the internal resistance of the cell via current interrupt technique near 50% state-of-charge in the charge cycle and multiplying that resistance in ohms by the cell area in cm². In this measurement, the cell is observed after turning off the current (i.e., at relaxation). FIG. 3 shows the final ASR for cells with two different catholytes: a 70:30 v/v mix of ethylene sulfite:sulfolane (ESS, which is labeled as 70:30 ESI:SLF), and a 45:55 v/v mix of ethylene carbonate:sulfolane (ECS, which is labeled as ECS 45.4). As shown in FIG. 3, there is a statistically significant difference between the final ASR, where the cells with ESS have a lower final ASR.

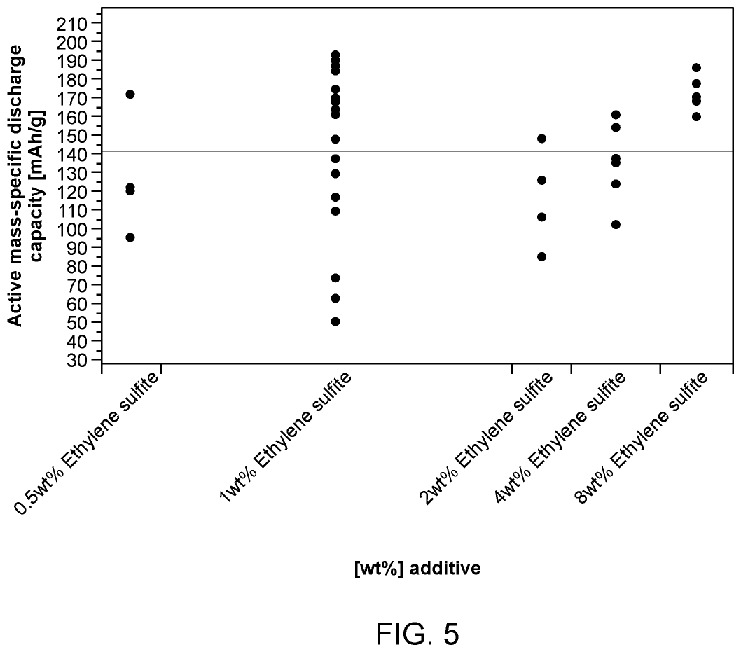

FIG. 5 shows the discharge capacity of cells after storage at 60° C. for one week with different additive amounts of ethylene sulfite additive: 0.5%, 1%, 2%, 4%, and 8% by weight in ECS. Cells with up to 8% ethylene sulfite have a high discharge capacity after storage.

Experiments were conducted to obtain the following data in the following Table 1. Cells were made and formed according to Example 1. The cells were then charged and discharged at a rate of C/3 between 3.4-4.35 V to measure an initial ASR (area-specific resistance) and then charged at C/3 to 4.35 V. C/3 is the current at which the battery is charged or discharged in 3 hours. The cells were held at open circuit voltage in a chamber at 60° C. for 7 days and then discharged at 25° C. at a rate of C/3 to 3.4V. The cells were then charged and discharged from 3.4-4.35 V at 25° C. at a rate of C/3 to measure a one-week ASR. An additional three-weeks storage at 60° C. occurred. A final ASR check was measured at 25° C. All ASR was measured at 25° C. Storage conditions included 4.35 V and 60° C.

TABLE 1

| | Median charge |
|---|---|
| Additive | ASRDC [Ω-cm²] |
| Li₂SO₄ | A |
| Li₂SO₄ | A |
| Li₂SO₄ | B |
| Li₂SO₄ | B |
| Li₂SO₄ | B |
| Li₂SO₄ | B |
| LiF | A |
| LiF | A |
| LiF | A |
| LiF | B |
| LiF | B |
| LiF | B |
| LiF | B |
| LiF | B |
| methyl acetate | B |
| methyl acetate | B |
| methyl acetate | B |
| methyl acetate | B |
| methyl acetate | B |
| methyl acetate | B |
| methyl acetate | B |
| methyl acetate | B |
| methyl acetate | C |
| methyl acetate | C |
| TMSB | B |
| TMSB | B |
| TMSB | B |
| TMSB | B |
| TMSB | B |
| TMSB | B |
| TMSB | B |
| TMSB | C |
| TTSPa | B |
| TTSPa | B |
| TTSPa | B |
| TTSPa | B |
| TTSPa | B |
| TTSPa | B |
| TTSPa | C |

In Table 1, A is 0 Ω-cm² to 59 Ω-cm²; B is 60 Ω-cm² to 100 Ω-cm²; and C is 60 Ω-cm² to 100 Ω-cm².

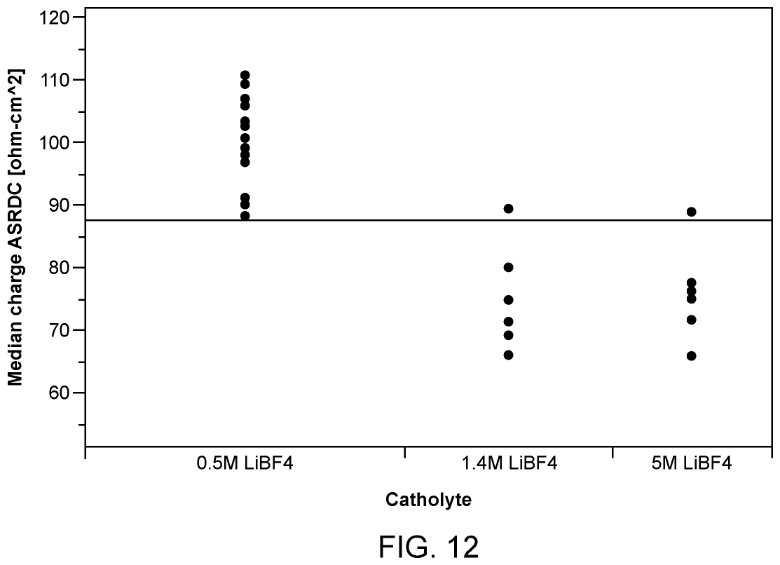

See FIG. 12 for a one-month ASR study for a catholyte molarity skew of 0.5M to 5M, wherein the molarity skew refers to the concentration of LiBF₄ salt in a catholyte of 70:30 v/v ethylene sulfite and sulfolane.

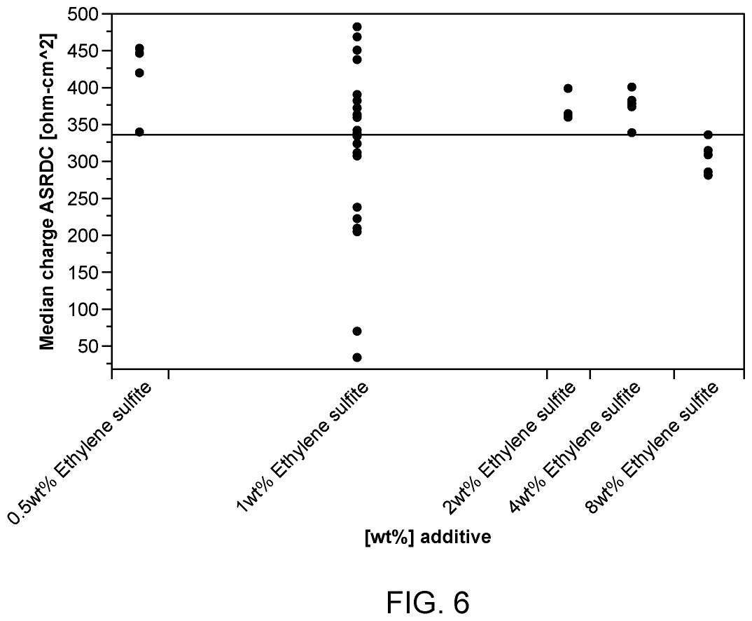

FIG. 6 shows the charge ASR after storage at 60° C. for one week with different amounts of ethylene sulfite additive: 0.5%, 1%, 2%, 4%, and 8% by weight in ECS. Cells with up to 8% ethylene sulfite have a lower charge ASR after storage.

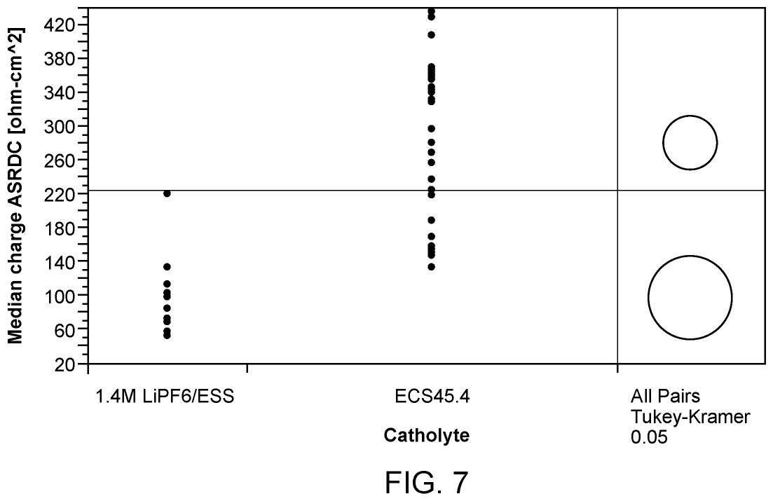

FIG. 7 shows the charge ASR after storage at 60° C. for one week with two different catholytes: 70:30 mix of ethylene sulfite:sulfolane with 1.4M LiPF₆ (ESS, labeled as 1.4M LiPF₆/ESS) versus 45:55 mix of ethylene carbonate:sulfolane with 1.4M LiPF₆ (ECS, labeled as ECS45.4). The charge ASR is lower for cells with ESS than with ECS after storage.

FIG. 12 shows the charge ASR after storage at 60° C. for one-month with three different catholytes: 70:30 mix of ethylene sulfite:sulfolane with 0.5 M LiBF₄, 1.4 M LiBF₄, or 5 M LiBF₄. The cells were then charged and discharged at a rate of C/3 between 3.4-4.35 V to measure an initial ASR (area-specific resistance) and then charged at C/3 to 4.35 V. C/3 is the current at which the battery is charged or discharged in 3 hours. The cells were held at open circuit voltage in a chamber at 60° C. for 7 days and then discharged at 25° C. at a rate of C/3 to 3.4V. The cells were then charged and discharged from 3.4-4.35 V at 25° C. at a rate of C/3 to measure a one-week ASR. An additional three-weeks storage at 60° C. occurred. A final ASR check was measured at 25° C. All ASR was measured at 25° C. Storage conditions included 4.35 V and 60° C.

### Example 4

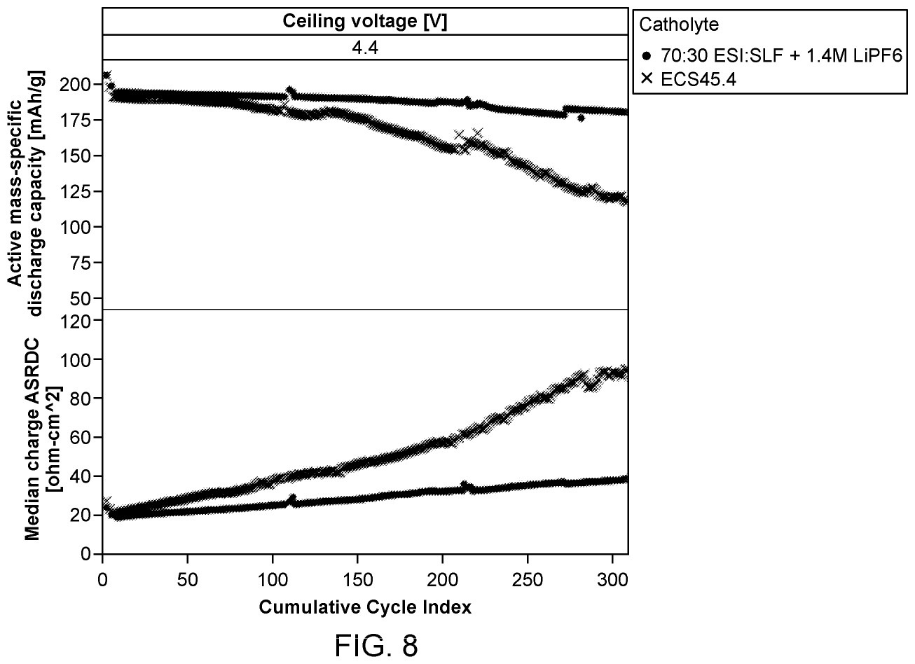

Cells were made according to Example 1. The cycle life of cells made with ESS (70:30 ethylene sulfite:sulfolane with 1.4M LiPF₆) and ECS (45:55 ethylene carbonate:sulfolane with 1.4M LiPF₆) were tested by cycling cells between 3-4.4V at 45° C. at a rate of C/3. FIG. 8 shows that the cycle life of the cell with ESS catholyte is superior to the cycle life of a cell with ECS catholyte.

### Example 5

Catholyte solutions were prepared by mixing ethylene sulfite (Sigma Aldrich 774251) and sulfolane (Sigma Aldrich T22209) in various ratios from 4:6 to 8:2, by volume, respectively, and including 1:1 and 7:3.

After mixing ethylene sulfite and sulfolane, the resulting mixture was dried over molecular sieves until the solution contained less than 10 parts-per-million (ppm) H₂O. The mixture was decanted away from the molecular sieves.

Lithium salt (LiPF₆ or LiBF₄) was added at a concentration ranging from 0.8 M to 2 M. The salt was added slowly to reduce the temperature rise.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

1-82. (canceled)

83-98. (canceled)

99. A catholyte solution comprising:
a lithium salt; and
an aprotic C₃-C₁₀ heterocyclic molecule comprising at least one sulfur (S) ring atom and optionally substituted with 1 to 6 substituents;
wherein the C₃-C₁₀ heterocyclic molecule is ethylene sulfite,
wherein the lithium salt is selected from the group consisting of LiPF₆, lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiF, LiCl, LiBr, LiI, and combinations thereof, and
wherein the lithium salt is present at a concentration of about 0.5 M to about 5.0 M.

100. The catholyte solution of claim 99, wherein the catholyte solution is in contact with a solid-state electrolyte comprising lithium-stuffed garnet, wherein the solid-state electrolyte is a thin film.

101. The catholyte solution of claim 99, wherein the lithium salt is present at a concentration of about 0.5 M to about 2.0 M.

102. The catholyte solution of claim 99, wherein the lithium salt is LiTFSI, LiBF₄, or combinations thereof.

103. The catholyte solution of claim 102, wherein the lithium salt is a combination of LiTFSI and LiBF₄.

104. The catholyte solution of claim 99, wherein the lithium salt is LiPF₆, LiFSI, or combinations thereof.

105. The catholyte solution of claim 104, wherein the lithium salt is a combination of LiPF₆ and LiFSI.

106. The catholyte solution of claim 102, wherein LiTFSI is present at a concentration of about 0.5 M.

107. The catholyte solution of claim 102, wherein LiBF₄ is present at a concentration of about 1.2 M to about 1.4 M.

108. The catholyte solution of claim 104, wherein LiFSI is present at a concentration of about 0.5 M.

109. The catholyte solution of claim 104, wherein LiPF₆ is present at a concentration of about 1.2 M to about 1.4 M.

110. The catholyte solution of claim 99, further comprising 1,3-propane sultone.

111. The catholyte solution of claim 99, further comprising thiophene.

112. The catholyte solution of claim 99, further comprising an additive selected from the group consisting of tris(trimethysilyl) phosphite (TTSPi); tris(trimethysilyl) phosphate (TTSPa); trimethoxyboroxine (C₃H₉B₃O₆); vinylene carbonate (VC); vinyl ethylene carbonate (VEC); methylene methane disulfonate (MMDS); prop-1-ene-1,3 sultone (PES); 1,3-propane sultone; fluoroethylene carbonate (FEC); LiTFSi; LiBOB; succinonitrile; trimethylene sulfate (TMS); triallyl phosphate (TAP); tris(trimethylsilyl) borate (TMSB); tris(pentafluorophenyl) borane (TPFPB); methyl acetate (MA); tris(trimethylsilyl) acetate (TMSA); tris(trimethylsilyl) pyridine; tris(trimethylsilyl) methacrylate (TMSMA); tris (2,2,2-trifluoroethyl) phosphite (TTFEP); tris(2,2,2-trifluoroethyl) borate (TTFEB); and combinations thereof.

113. The catholyte solution of claim 112, wherein the additive is TTSPi.

114. The catholyte solution of claim 112, wherein the additive is TTSPa.

115. The catholyte solution of claim 112, wherein the additive is TTFEP.

116. The catholyte solution of claim 100, wherein the solid-state electrolyte is a lithium-stuffed garnet characterized by a formula selected from the group consisting of Li_{A}La_{B}M′_{C}M″_{D}Zr_{E}O_{F}, Li_{A}La_{B}M′_{C}M″_{D}Ta_{E}O_{F}, and Li_{A}La_{B}M′_{C}M″_{D}Nb_{E}O_{F}, wherein 4<A<8.5, 1.5<B<4, 0≤C<2.5, 0≤D<2.5; 0<E<2.5, 10<F<14, and wherein M′ and M″ are each, independently, selected from the group consisting of Al, Mo, W, Nb, Ga, Y, Gd, Sb, Ca, Ba, Sr, Ce, Hf, Rb, and Ta.

117. An electrochemical cell comprising the solution of claim 99.

118. A method for making a catholyte solution, comprising:
mixing an aprotic C₃-C₁₀ heterocyclic molecule comprising at least one sulfur (S) ring atom and optionally substituted with 1 to 6 substituents; wherein the C₃-C₁₀ heterocyclic molecule is ethylene sulfite; and
a lithium salt; wherein lithium salt is selected from the group consisting of LiPF₆, Lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiF, LiCl, LiBr, LiI, and combinations thereof; wherein the lithium salt is present at a concentration of about 0.5 M to about 5.0 M;
thereby providing the catholyte solution.
